(19) United States
(12) Patent Application Publication
(10) Pub. No.: US 2018/0040259 A1
(43) Pub. Date: Feb. 8, 2018

(54) SYSTEMS, APPARATUS, AND METHODS FOR APPLYING ASTROLOGY

(71) Applicant: Remi Muinatu IBRAHEEM, Gloucester, MA (US)

(72) Inventor: Remi Muinatu IBRAHEEM, Gloucester, MA (US)

(21) Appl. No.: 15/668,846

(22) Filed: Aug. 4, 2017

Related U.S. Application Data
(60) Provisional application No. 62/371,542, filed on Aug. 5, 2016.

(51) Int. Cl. G09B 19/00; G09B 27/04

(52) U.S. Cl. CPC G09B 19/00; G09B 27/04

(57) ABSTRACT

An embodiment is disclosed for facilitating a writing project using astrology, the writing project concerning at least one of a character, object, place, and event, by determining a date, a time, and a place of birth for the at least one of a character, object, place, and event; acquiring an astrological chart based on the date, the time, and the place of birth for the at least one of a character, object, place, and event, wherein the astrological chart comprises twelve houses situated along a path of an ecliptic; transposing the astrological chart on a storyboard to create an astrological story map by delineating, for each house, a cusp and any planets on the storyboard, beginning on an ascendant in direction east on the astrological chart, and moving along the path of the ecliptic, such that each house represents a section of the writing project; replacing, for any planets on the astrological story map, each planet with at least one of a correlating character, correlating object, correlating place, and correlating event, such that each of the at least one of a correlating character, correlating object, correlating place, and correlating event interacts with the at least one of a character, object, place, and event in one section of the writing project; and providing the astrological story map to an author of the writing project.

### CROSS-REFERENCE TO RELATED APPLICATIONS

This application claims the priority benefit, under 35 U.S.C. §119(e), of U.S. Application No. 62/371,542, entitled “Systems Apparatus and Methods for Applying Astrology,” filed on Aug. 5, 2016, the disclosure of which is incorporated herein by reference in its entirety.

### TECHNICAL FIELD

This disclosure relates to methods and systems for using astrology as tools to provide practical and tangible solutions to everyday problems in life, work, and art. In particular, various embodiments use and integrate birth data of people, places, things, and events to create tangible products including, but not limited to, outlines, stories, novels, reports, business plans, life plans, management methods, conflict resolutions, and musical compositions.

### BACKGROUND

Astrology is the study of how the positions of the stars and planets have an influence on events and on the lives and behavior of people. Astrology may be considered both a science and an art form. For thousands of years, scientists, philosophers, and laypeople have looked to the skies for answers. They have calculated and measured the motions of the heavens in order to better understand the events taking place on Earth. Through the centuries, from the days of Babylonia, known to be the birthplace of astrology, humanity has attempted to bring order to the seemingly unpredictable and chaotic world around them. Many cultures have formulated their own versions and tools for the practice and use of astrology; unique versions of astrology have incarnated from Tibet, India, China, the Middle East, Africa, the Americas, and Europe. But they all share a common denominator as their foundation—the path of the sun through the ecliptic of the sky throughout the day and, most importantly, the year. The ecliptic is the great circle formed by the intersection of the plane of the earth's orbit with the celestial sphere, along which are located the twelve houses and signs of the zodiac.

Astrology uses the astronomical cycle of the stars and archetypal data collected by humanity over the course of thousands of years. Data collected from the patterns in the skies that correlate to events on Earth were used to formulate the standard language of ancient and modern astrology. Planets took on representations of the human psyche and became archetypal symbols just as the astrological signs became representative of the elemental qualities and time of year the planets transited around the sun and globe. The elements (also called signs) of nature are Fire, Water, Air, and Earth. These elements or signs are the building blocks of the twelve zodiac signs. Each zodiac sign corresponds to a major area of an individual's life called a house. Each house has a beginning point called the cusp. The archetypal planets rule the corresponding signs and houses. In most astrological chart systems, the sign located on the cusps determine which planet rules a particular house in an astrology chart and therefore controls that area of life for an individual.

Astronomy and astrology converge in the development of the natal chart (also known as the birth chart). Using an individual's date, time, and location of birth, the natal chart provides a snapshot of the locations of the celestial bodies in the sky at the moment of an individual's birth. The traditional Western natal chart is represented by a circle, which contains twelve equal sections that represent the twelve zodiac signs or houses of astrology.

Although there are generalized indicators that allow an astrologer to determine which areas of life are being activated in an individual's chart, the specifics of who or what represents common themes in the individual's life (e.g., mother, father, sibling, etc.) are difficult to ascertain and can provide a limitation to the astrologer. As diverse as we are in society, we are still limited to constraints that are set forth by the rules of what we consider to be mothers, fathers, and siblings. Although these common themes are common for a reason, evolutionarily, an individual's reality can be more complex. In the analysis of the modern natal chart, a mother can represent an enemy figure or a sibling figure and not just a mother; therefore, the modern use of the chart can provide limitations. Although these connections can be made through aspects, a deeper analysis can be gained when the decider of the symbol is put into the hands of the individual whose chart we analyze as opposed to the normative construct indicated by the representations given to the planets, signs, and houses.

Historically, astrology was used as a means to create tangible solutions for the survival of humanity. In ancient times, the path of the sun through the sky determined when to plant, grow, and harvest crops. It also helped the ancients predict and respond to certain events.

In modern times, however, astrology has become more of a tool for entertainment purposes. Some people use astrology to better understand their character traits, behaviors, and patterns. Most people know their astrological sun sign and its corresponding character traits even if they do not associate with or understand a deeper meaning. An astrologer may provide advice or guidance; however, their guidance is typically limited to universal archetypes of the planetary bodies rather than addressing an individual's unique situation.

### SUMMARY

Embodiments of the present disclosure include methods and systems for using astrology to provide practical and tangible solutions to everyday problems in life, work, and art. According to some embodiments, methods and systems are disclosed for using and integrating birth data of people, places, things, and events to create tangible products including, but not limited to, outlines, stories, novels, reports, business plans, life plans, management methods, conflict resolutions, and musical compositions.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Other systems, processes, and features will become apparent to those skilled in the art upon examination of the following drawings and detailed description. It is intended that all such additional systems, processes, and features be included within this description, be within the scope of the present invention, and be protected by the accompanying claims.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIGS. 1-22 are screenshots illustrating a user interface in accordance with some embodiments.

FIG. 23 is an astrological chart illustrating planets, signs/element, houses, and qualities corresponding to a time and place in accordance with some embodiments.

FIG. 24 is a diagram illustrating a “W” storyboard in accordance with some embodiments.

FIG. 25 illustrates the process of transposing an astrological chart and a storyboard structure in accordance with some embodiments.

FIGS. 26-27 are diagrams illustrating populated W storyboards in accordance with some embodiments.

FIGS. 28-43 are screenshots illustrating a user interface in accordance with some embodiments.

FIGS. 44-46 are diagrams illustrating populated W storyboards in accordance with some embodiments.

FIG. 47 is a diagram illustrating the ecliptic in accordance with some embodiments.

FIG. 48 is an astrological chart illustrating houses, signs, planets, and cusps in accordance with some embodiments.

FIGS. 49 and 50 are diagrams illustrating W storyboards in accordance with some embodiments.

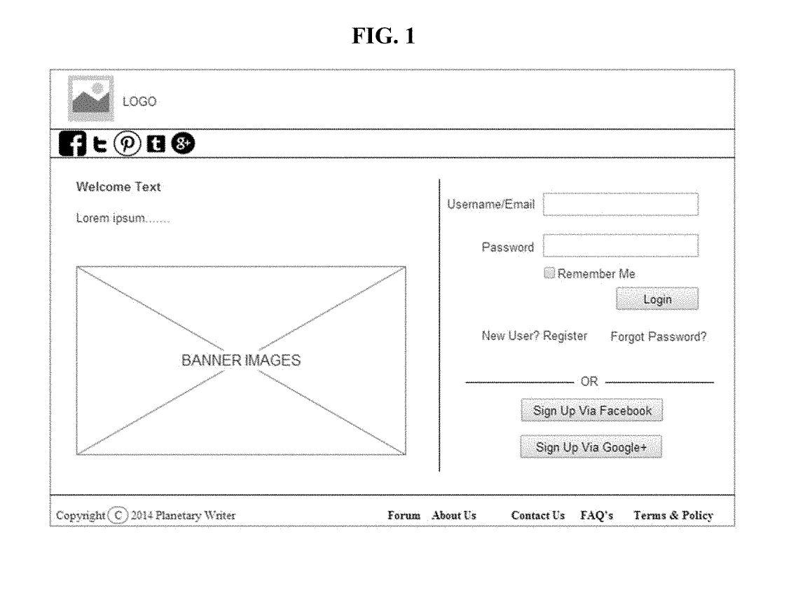

### DETAILED DESCRIPTION

What distinguishes embodiments disclosed herein from the modern use of astrology is the added layer of interpretation that is more specific and intimate for the individual and/or the astrologer. In the practice of acupuncture, a cold is not just a cold; the practitioner must assess the patient on an individual pathological level to determine the type of cold that is specific to that individual in order to provide an effective treatment. Treating one patient's cold the same as another can have adverse effects. In this same way, some embodiments embed the overall themes of the planets, signs, and houses into the intimate life of the individual. No longer will planetary symbols such as Mercury just represent communication for the individual. Planetary symbols and themes will also represent the real life person, place, place, thing, event, character, etc., on which the individual imposes these planetary symbols and associated themes. This provides a deeper analysis of the individual's life where specifics can be identified for actions or solutions.

According to some embodiments, astrology is used much like the ancients used it—as a means of creating tangible solutions to problems. Various fields of astrology are evolving that aim to tackle evolutionary questions and problems. In some embodiments, the traditional natal chart is used to reconstruct new charting systems that are aligned with the problem one aims to solve in a new and more intimate way as seen in the first embodiment. It correlates people, places, things, events in life (real or fictional that are specific to the individual), to planetary archetypes, signs and houses in a natal or other chart and creates tangible products including, without limitation, novels, documentaries, health plans, psychological analyses, business plans, life plans, marketing plans, musical compositions, etc.

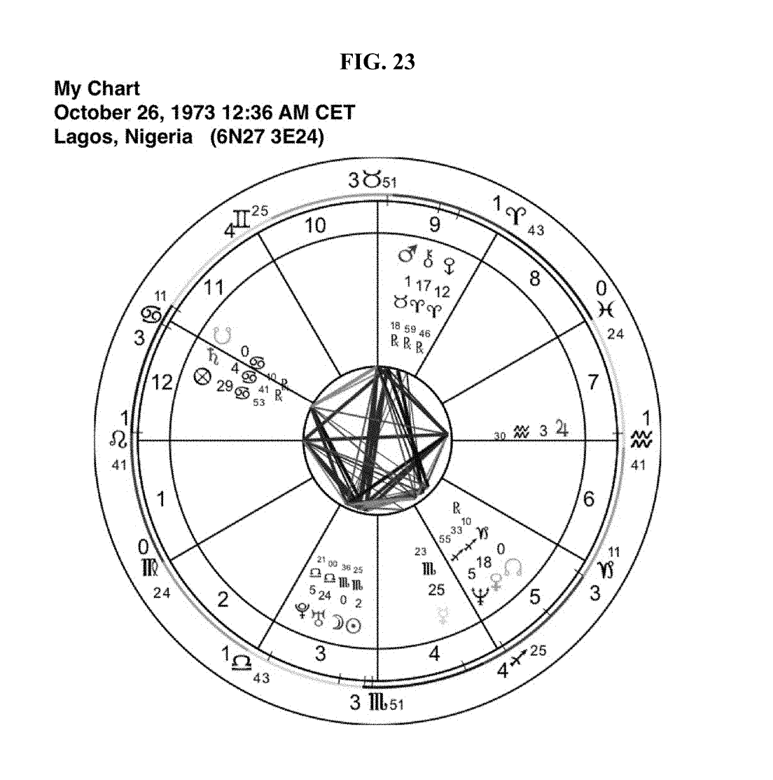

According to some embodiments, a writing tool for a novel, story, screenplay, documentary, memoir, play, or other written product is provided. A writer enters the date, time, and place of birth of the work, a character, place, object or event and creates a traditional natal chart. A circular natal chart is used as an example, but any other astrological charting systems may be used to create a natal chart including Vedic astrology as well as various housing system used such as Equal Houses, Campanus, Regiomontanus, Natural, Whole Sign, Porphyry, Koch, Placidus, etc. The chart in FIG. 23 shows the planets and signs as a snapshot in the natal chart at the time of birth of the individual, character, event, object, business, etc. The inner lines indicate the aspects or angle of each planet in relation to each other.

Questions for the planetary grid are specific to the industry or product that a solution is being sought. Archetypal questions are created that correlate to and are specific to the type of answers the writer needs, for example, questions should be about characters. TABLE 1, below, shows an example planetary archetype grid according to some embodiments.

TABLE 1

| Planets | Role in Novel | Character |
|---|---|---|
| ⊙ Sun/Generator | Description of Character | Name of Characters, places or |
| Leo | archetype | things that the user feels |
| 5^{th} house | Protagonist Keywords: | represents the archetype. |
| | Antagonist Keywords: | |
| [symbol] Moon/Incandescent | Description of Character | Name of Characters, places or |
| Depths | archetype | things that the user feels |
| Cancer | Protagonist Keywords: | represents the archetype. |
| 4^{th} house | Antagonist Keywords: | |
| [symbol] Mercury/Technician of | Gemini - Description of | Name of Characters, places or |
| Logic | Character archetype | things that the user feels |
| Gemini and Virgo | Protagonist Keywords: | represents the archetype. |
| 3^{rd} and 6^{th} | Antagonist Keywords: | |
| | Virgo Description of | |
| | Character archetype | |
| | Protagonist Keywords: | |
| | Antagonist Keywords: | |
| ♀ Venus/Elemental | Taurus Description of | Name of Characters, places or |
| Playground | Character archetype | things that the user feels |
| Taurus and Libra | Protagonist Keywords: | represents the archetype. |
| 2^{nd} and 7^{th} house | Antagonist Keywords: | |
| | Libra Description of | |
| | Character archetype | |
| | Protagonist Keywords: | |
| | Antagonist Keywords: | |
| Earth/Part of Fortune | Description of Character | Name of Characters, places or |
| | archetype | things that the user feels |
| | Protagonist Keywords: | represents the archetype. |
| | Antagonist Keywords: | |
| ♂ Mars/Soldier's Quest | Description of Character | Name of Characters, places or |
| Aries | archetype | things that the user feels |
| 1^{st} house | Protagonist Keywords: | represents the archetype. |
| | Antagonist Keywords: | |
| [symbol] Jupiter/Benefactor's | Description of Character | Name of Characters, places or |
| Crusade | archetype | things that the user feels |
| Sagittarius | Protagonist Keywords: | represents the archetype. |
| 9^{th} house | Antagonist Keywords: | |
| [symbol] Saturn/The Wish Maker | Description of Character | Name of Characters, places or |
| Capricorn | archetype | things that the user feels |
| 10^{th} house | Protagonist Keywords: | represents the archetype. |
| | Antagonist Keywords: | |
| [symbol] Uranus/Defiant | Description of Character | Name of Characters, places or |
| Spirit | archetype | things that the user feels |
| Aquarius | Protagonist Keywords: | represents the archetype. |
| 11^{th} house | Antagonist Keywords: | |
| [symbol] | Description of Character | Name of Characters, places or |
| Neptune/Collective | archetype | things that the user feels |
| Fountain | Protagonist Keywords: | represents the archetype. |
| Pisces | Antagonist Keywords: | |
| 12^{th} house | | |
| [symbol] Pluto/Assassin of Decay | Description of Character | Name of Characters, places or |
| Scorpio | archetype | things that the user feels |
| 8^{th} house | Protagonist Keywords: | represents the archetype. |
| | Antagonist Keywords: | |
| Eris/Integration of Being | Description of Character | Name of Characters, places or |
| | archetype | things that the user feels |
| | Protagonist Keywords: | represents the archetype. |
| | Antagonist Keywords: | |
| [symbol] Chiron/Exposed Loci | Description of Character | Name of Characters, places or |
| | archetype | things that the user feels |
| | Protagonist Keywords: | represents the archetype. |
| | Antagonist Keywords: | |
| [symbol] North Node/Soul's | Description of Character | Name of Characters, places or |
| Passage | archetype | things that the user feels |
| | Protagonist Keywords: | represents the archetype. |
| | Antagonist Keywords: | |
| [symbol] South | Description of Character | Name of Characters, places or |
| Node/Relinquished | archetype | things that the user feels |
| Solace | Protagonist Keywords: | represents the archetype. |
| | Antagonist Keywords: | |
| Other Asteroids that will | Description of Character | Name of Characters, places or |
| be hidden unless the | archetype | things that the user feels |
| writer decides it is needed | Protagonist Keywords: | represents the archetype. |
| in their story | Antagonist Keywords: | |

The writer then answers archetypal questions that correspond to celestial locations (e.g., celestial bodies such as astrological planets, and asteroids, nodes and/or the like). TABLE 2, below, shows characters that have been filled in a planetary archetype grid according to some embodiments. This connects characters to planetary archetypes, signs and houses. The C characters are representative of character, people, projects, places things, event, names etc. that users have created for their product.

TABLE 2

| Planets | Role in Novel | Character |
|---|---|---|
| ⊙ Sun/Generator | Description of Character | C1 |
| Leo | archetype | |
| 5^{th} house | Protagonist Keywords: | |
| | Antagonist Keywords: | |
| [symbol] Moon/Incandescent | Description of Character | C2 |
| Depths | archetype | |
| Cancer | Protagonist Keywords: | |
| 4^{th} house | Antagonist Keywords: | |
| [symbol] Mercury/Technician of | Gemini - Description of | C3 |
| Logic | Character archetype | C4 |
| Gemini and Virgo | Protagonist Keywords: | |
| 3^{rd} and 6^{th} | Antagonist Keywords: | |
| | Virgo Description of | |
| | Character archetype | |
| | Protagonist Keywords: | |
| | Antagonist Keywords: | |
| ♀ Venus/Elemental | Taurus Description of | C5 |
| Playground | Character archetype | C6 |
| Taurus and Libra | Protagonist Keywords: | |
| 2^{nd} and 7^{th} house | Antagonist Keywords: | |
| | Libra Description of | |
| | Character archetype | |
| | Protagonist Keywords: | |
| | Antagonist Keywords: | |
| Earth/Part of Fortune | Description of Character | C7 |
| | archetype | C8 |
| | Protagonist Keywords: | |
| | Antagonist Keywords: | |
| ♂ Mars/Soldier's Quest | Description of Character | C9 |
| Aries | archetype | |
| 1^{st} house | Protagonist Keywords: | |
| | Antagonist Keywords: | |
| [symbol] Jupiter/Benefactor's | Description of Character | C10 |
| Crusade | archetype | |
| Sagittarius | Protagonist Keywords: | |
| 9^{th} house | Antagonist Keywords: | |
| [symbol] Saturn/The Wish Maker | Description of Character | C11 |
| Capricorn | archetype | |
| 10^{th} house | Protagonist Keywords: | |
| | Antagonist Keywords: | |
| [symbol] Uranus/Defiant | Description of Character | C12 |
| Spirit | archetype | |
| Aquarius | Protagonist Keywords: | |
| 11^{th} house | Antagonist Keywords: | |
| [symbol] | Description of Character | C13 |
| Neptune/Collective | archetype | |
| Fountain | Protagonist Keywords: | |
| Pisces | Antagonist Keywords: | |
| 12^{th} house | | |
| [symbol] Pluto/Assassin of Decay | Description of Character | C14 |
| Scorpio | archetype | |
| 8^{th} house | Protagonist Keywords: | |
| | Antagonist Keywords: | |
| Eris/Integration of Being | Description of Character | C15 |
| | archetype | Should also be a character |
| | Protagonist Keywords: | that represents a known |
| | Antagonist Keywords: | planet because they do not |
| | | rule a house |
| [symbol] Chiron/Exposed Loci | Description of Character | C16 |
| | archetype | Should also be a character |
| | Protagonist Keywords: | that represents a known |
| | Antagonist Keywords: | planet because they do not |
| | | rule a house |
| [symbol] North Node/Soul's | Description of Character | C17 |
| Passage | archetype | Should also be a character |
| | Protagonist Keywords: | that represents a known |
| | Antagonist Keywords: | planet because they do not |
| | | rule a house |
| [symbol] South | Description of Character | C18 |
| Node/Relinquished Solace | archetype | Should also be a character |
| | Protagonist Keywords: | that represents a known |
| | Antagonist Keywords: | planet because they do not |
| | | rule a house |
| Other Asteroids that will | Description of Character | C19, C20, etc. |
| be hidden unless the writer | archetype | Should also be a character |
| decides it is needed in | Protagonist Keywords: | that represents a known |
| their story | Antagonist Keywords: | planet because they do not |
| | | rule a house |

The characters, places, things or events take the place of the planets, houses and signs in the new map. In the natal chart, the character of C1 will take the place of the Sun, Leo, and the 5^{th} house. This is repeated with all celestial bodies and their corresponding character, person, thing, etc. A character that is designated to a planet is also designated to the planet's natural house and sign in the new astrological chart system, referred to herein as “physical astrology.” TABLE 3, below, shows a planetary legend for a physical astrology story map according to some embodiments.

TABLE 3

| Planets | Character |
|---|---|
| ⊙ Sun/Generator | C1 |
| Leo | |
| 5^{th} house | |
| [symbol] Moon/Incandescent | C2 |
| Depths | |
| Cancer | |
| 4^{th} house | |
| [symbol] Mercury/Technician of Logic | Gemini character -C3 |
| Gemini and Virgo | C4 |
| 3^{rd} and 6^{th} | |
| ♀ Venus/Elemental Playground | C5 |
| Taurus and Libra | C6 |
| 2^{nd} and 7^{th} house | |
| Earth/Part of Fortune | C7 |
| | C8 |
| ♂ Mars/Soldier's Quest | C9 |
| Aries | |
| 1^{st} house | |
| [symbol] Jupiter/Benefactor's | C10 |
| Crusade | |
| Sagittarius | |
| 9^{th} house | |
| [symbol] Saturn/The Wish Maker | C11 |
| Capricorn | |
| 10^{th} house | |
| [symbol] Uranus/Defiant Spirit | C12 |
| Aquarius | |
| 11^{th} house | |
| [symbol] | C13 |
| Neptune/Collective Fountain | |
| Pisces | |
| 12^{th} house | |
| [symbol] Pluto/Assassin of Decay | C14 |
| Scorpio | |
| 8^{th} house | |
| Eris/Integration of Being | C15 |
| | Should also be a character |
| | that represents a known |
| | planet because they do not |
| | rule a house |
| [symbol] Chiron/Exposed Loci | C16 |
| | Should also be a character |
| | that represents a known |
| | planet because they do not |
| | rule a house |
| [symbol] North Node/Soul's | C17 |
| Passage | Should also be a character |
| | that represents a known |
| | planet because they do not |
| | rule a house |
| [symbol] South | C18 |
| Node/Relinquished Solace | Should also be a character |
| | that represents a known |
| | planet because they do not |
| | rule a house |
| Other | C19, C20, etc. |
| Celestial bodies and | Should also be a character |
| Asteroids that will be hidden | that represents a known |
| unless the writer decides it is | planet because they do not |
| needed in their story | rule a house |

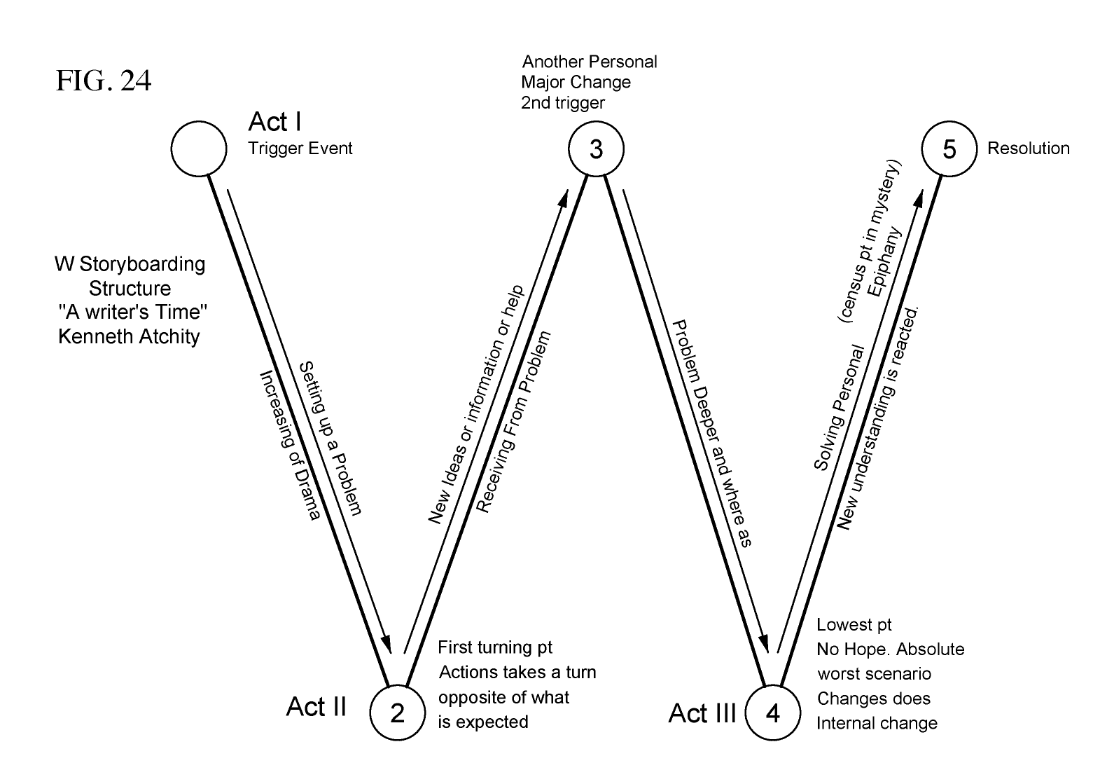

In fictional writing, a W storyboarding map structure is often used to create an outline as seen in FIG. 24. The map has five points (circles) that are drawn at major turning points of the story. The upper circles/markers on the W map denote area where the three-act rule of story writing intersects. The lower circles on the W map denote major turning points in the story (A). The first circle is the beginning of Act I, the triggering event that begins the story and an arrow is drawn leading down to the second circle indicating the setup of the problem(s) in the fictional story (B). The second circle on the map indicates the first trigger that forces the character to invest in the resolution of problem. This moment has an arrow leading towards the third circle and the intersection of Act II (C). The third circle depicts the turning of the story and leads downward on the W storyboard map to the fourth circle. This indicates a deepening and worsening of the problem that leads to the fourth circle (D). The fourth circle begins at the lowest point of the story and has an arrow moving upward on the W map towards the 5^{th} and final circle. It shows the manner in which the problem is resolved and the end of the third Act (E).

The natal chart is then transposed onto the W or other storyboarding map. Other writing methods can be transposed onto the map to create tools for various genres in fiction and nonfiction writing.

The cusps of each house are delineated on the W story boarding map beginning from ascendant. The 12^{th} house of the astrological chart takes position immediately following the first circle (ascendant) on the W storyboard map.

The first circle of the W map begins on the ascendant in the east on an astrological chart. This is the beginning of the novel. The sign and its ruler on the ascendant indicate the character that is involved in the activating event of the novel. Any means of astrological interpretation and knowledge applies in the process of analysis.

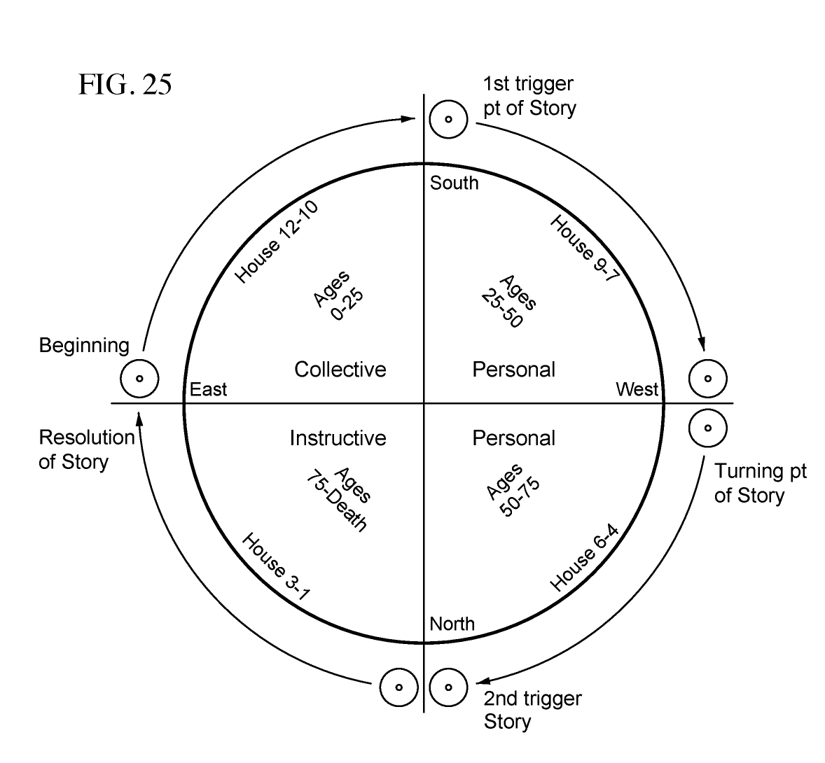

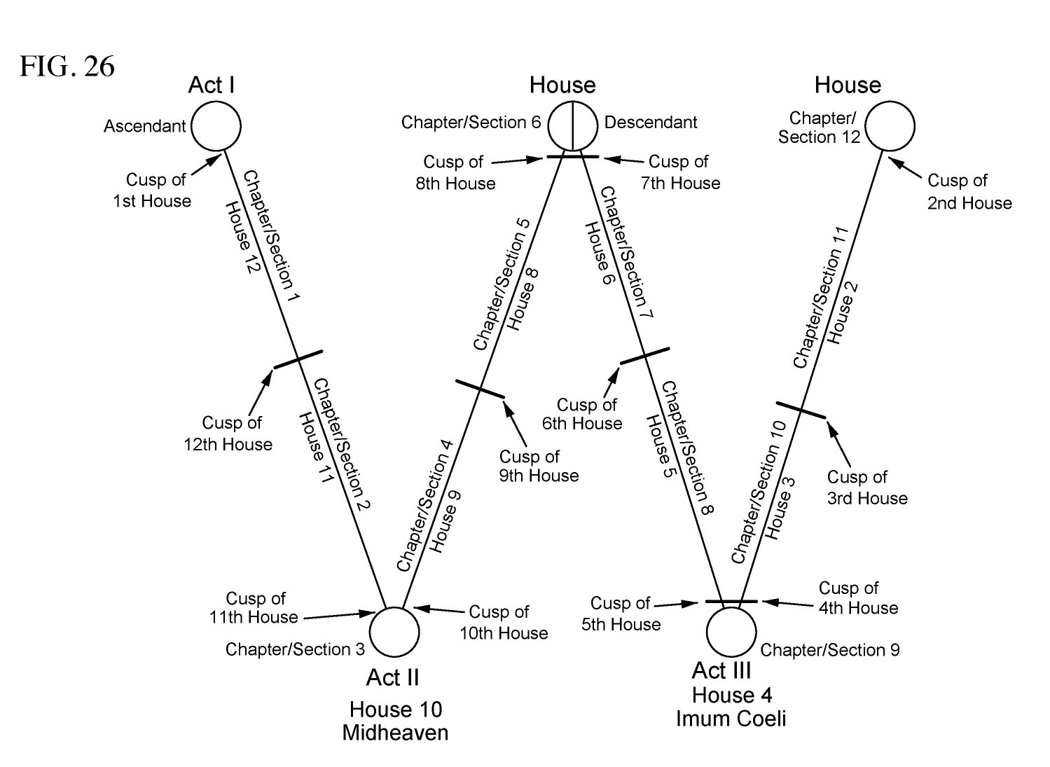

Moving along the path of the sun as seen in FIGS. 25-27. The astrological chart and the W storyboard map are transposed on each other beginning with the line of the ascendant then house 12. Houses 11, 10, 9, 8 7, 6, 5, 4, 3, 2, and 1 are placed along the delineated W storyboard map respectively. Houses 10, 7, 4 and 1 fill the position of the circles (literal turning points on the W storyboard map as well as the astrological chart of the work and characters).

Each house on the new Planetary Write story map (PW-SM) represents a section or a chapter of the work. Each house also corresponds to a planet and a planetary body. Because there are 12 houses in the astrological chart indicating the complete cycle of the day and the year, there are 12 sections or chapter in the work total. A section is created based on the authors/creator's needs. There can be multiple chapters within a section or simply twelve chapters total but each house in an astrological chart does represent each section or chapter on the PW-SM.

Planets in signs found in each house of the astrological chart are also placed in their corresponding section on the PW story map. Where there are no planets, signs remain filling the entire storyboard with either a sign or a planet in a sign.

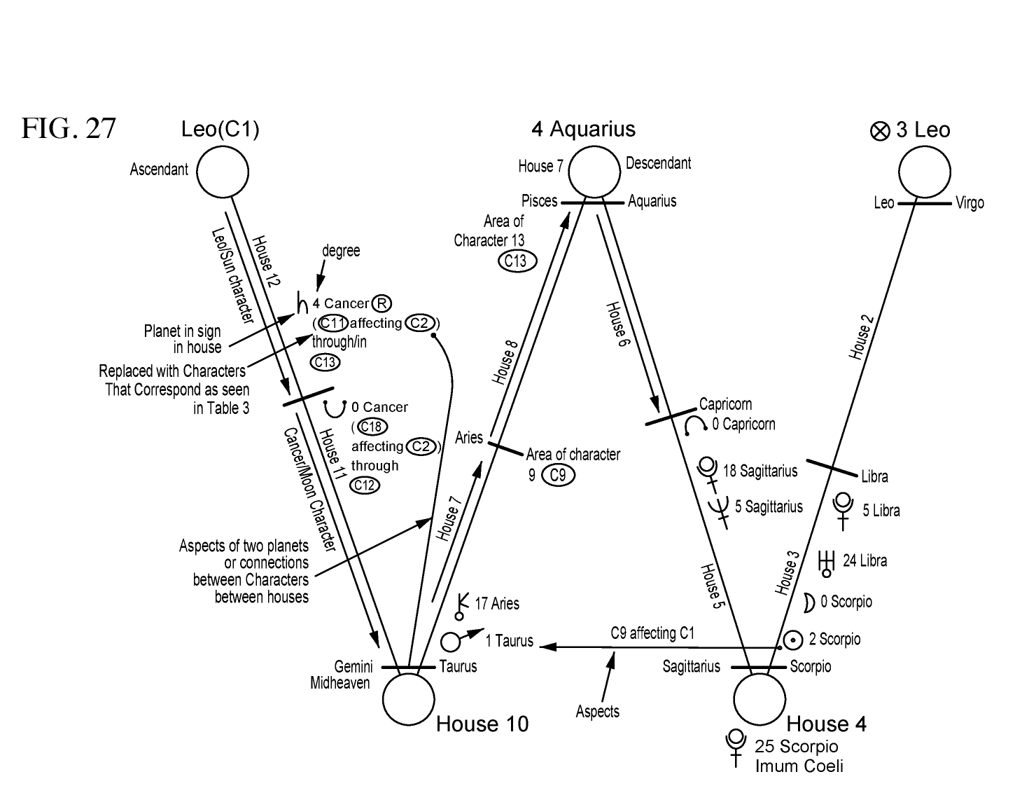

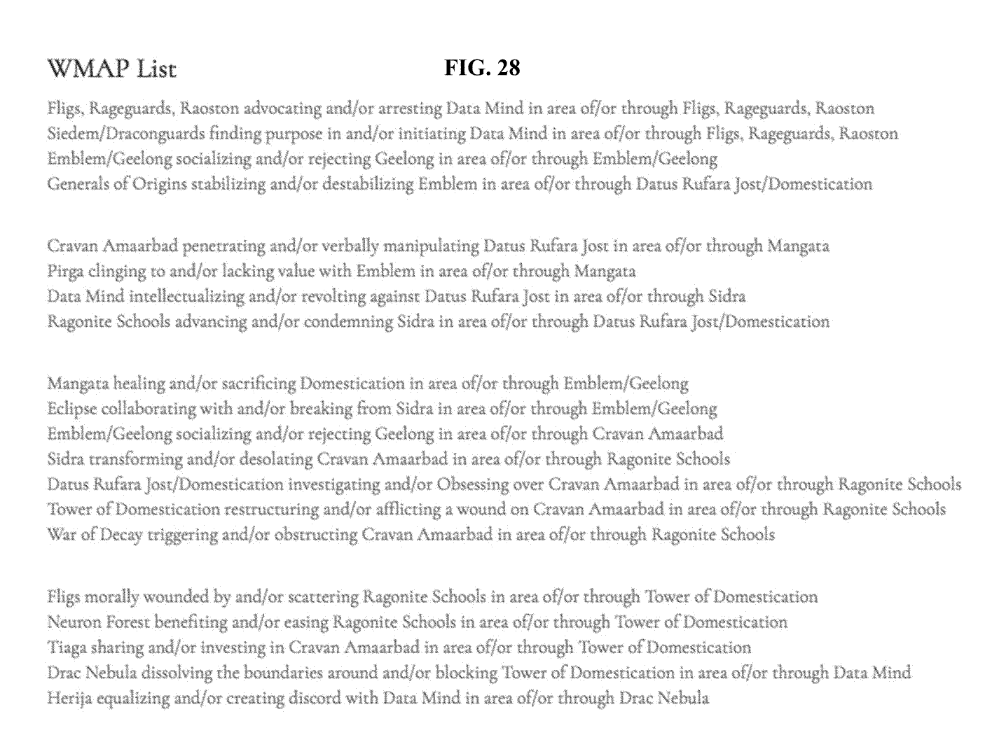

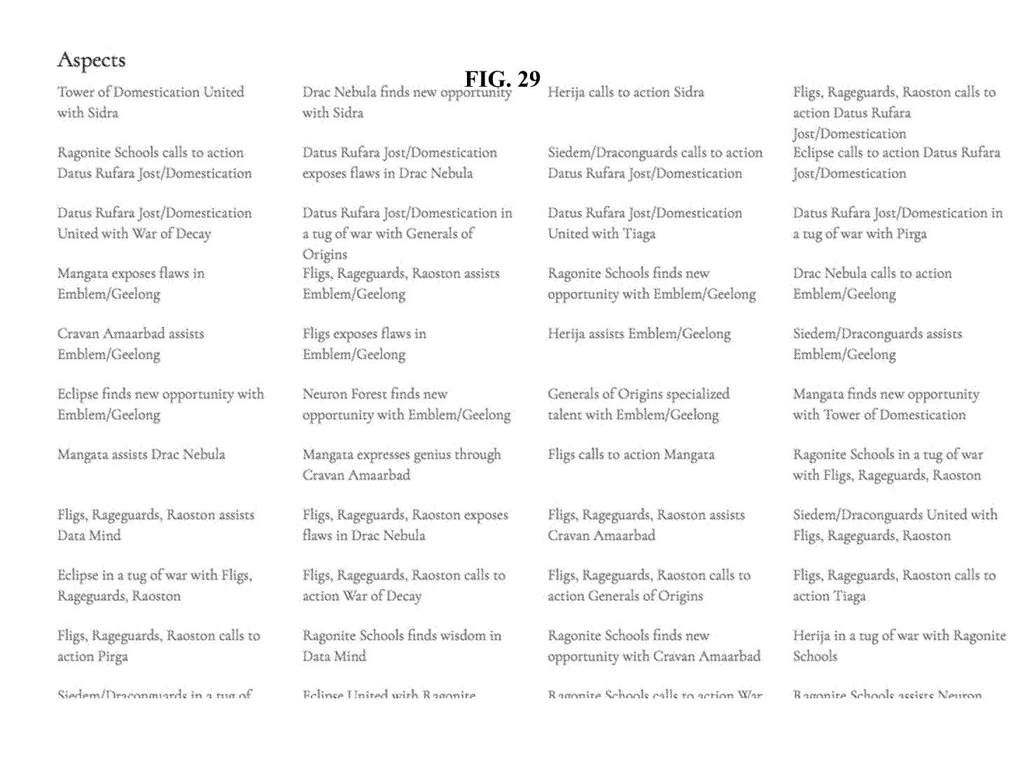

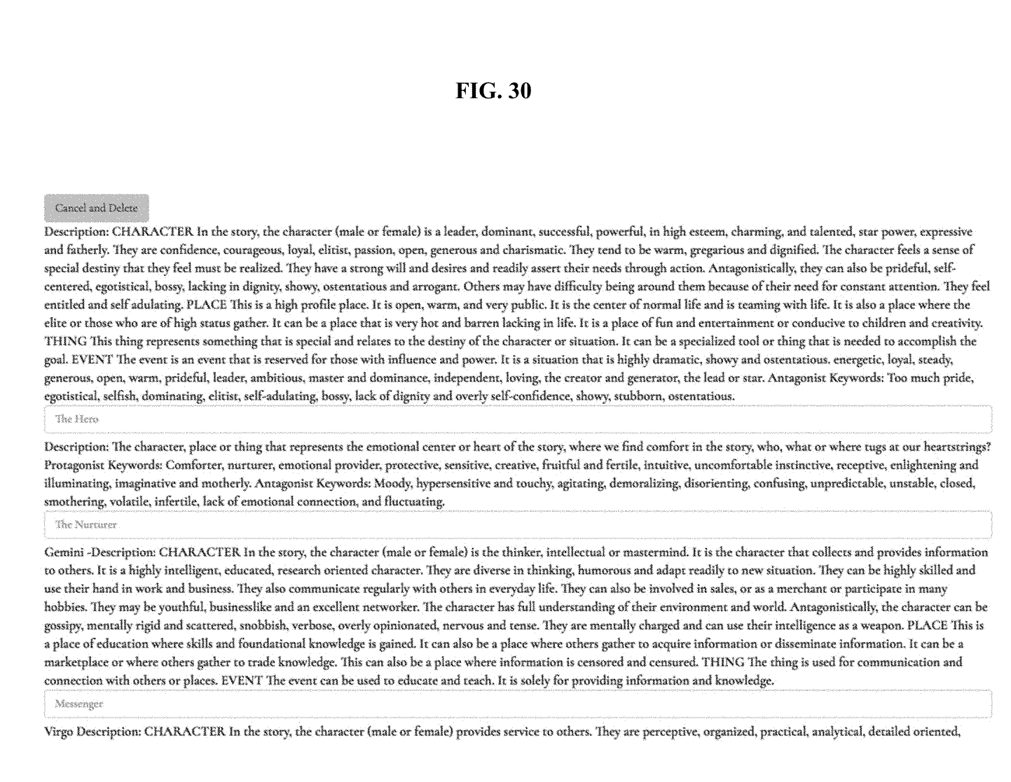

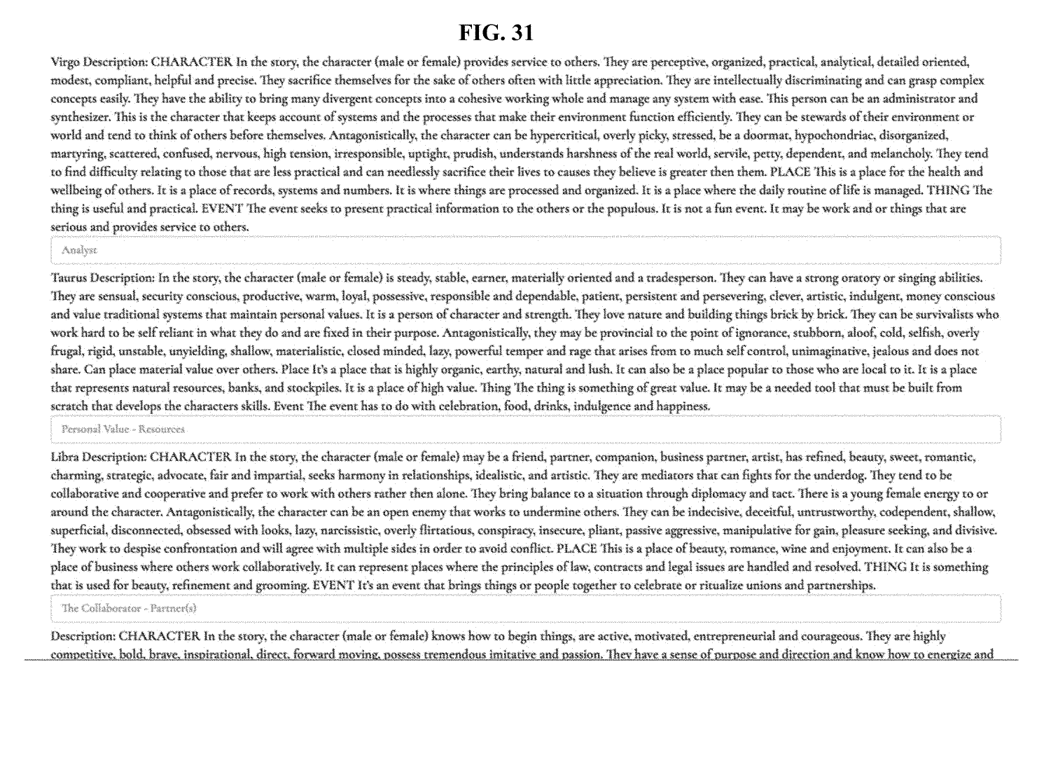

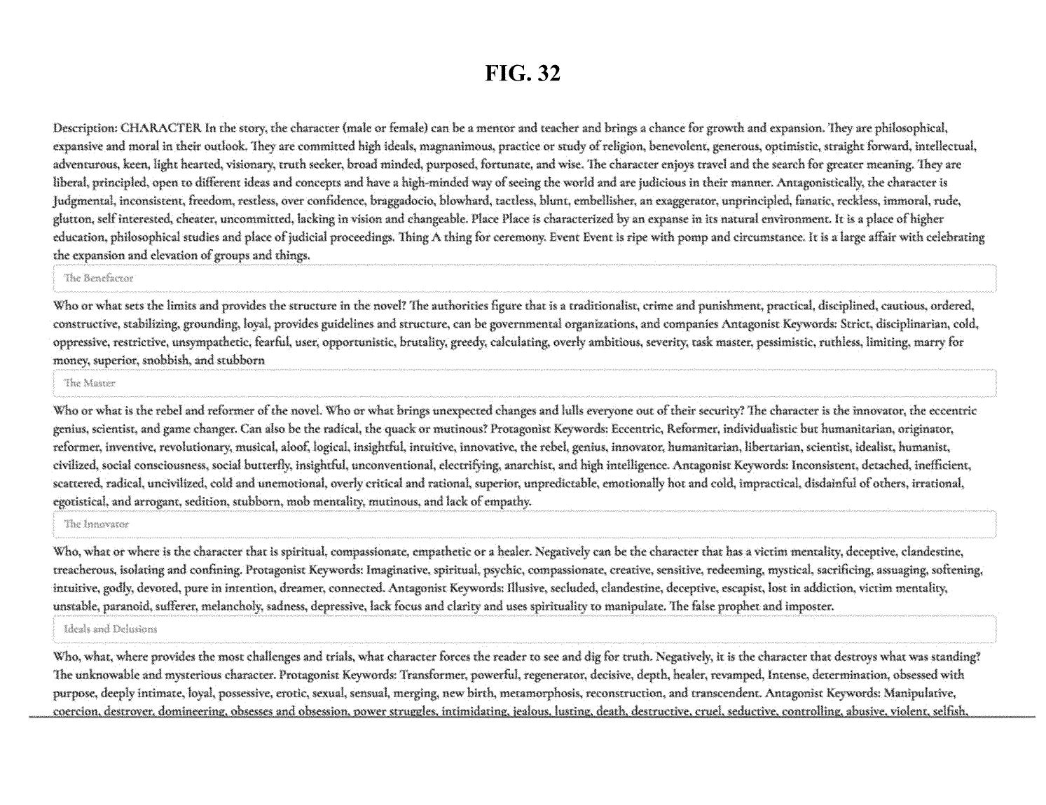

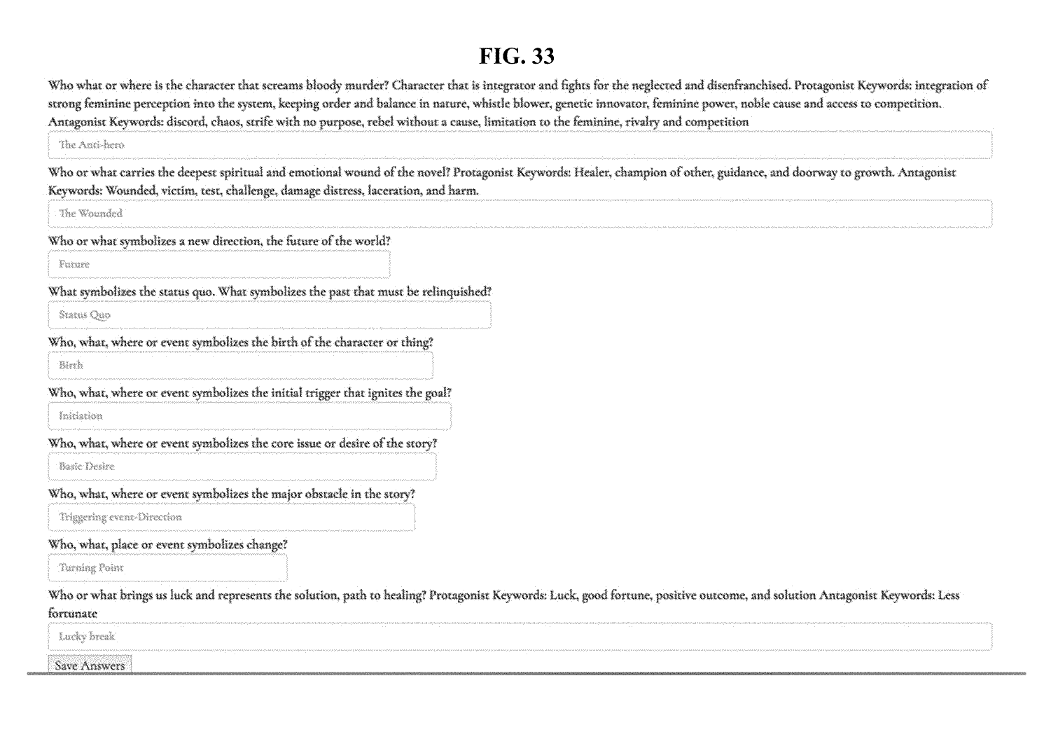

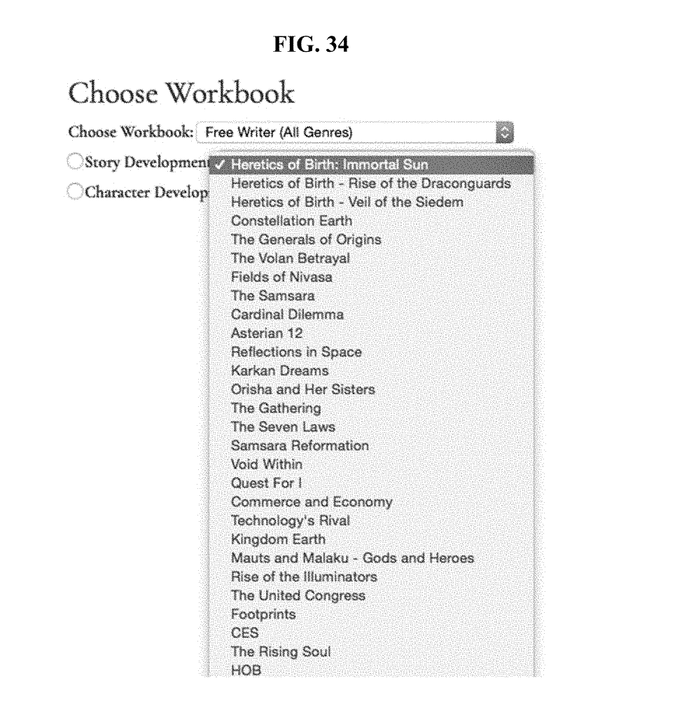

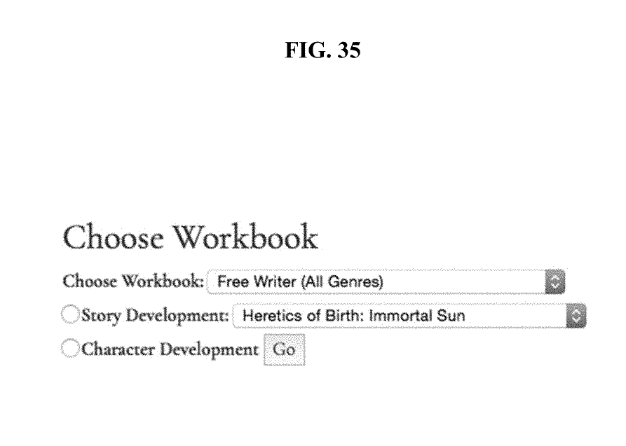

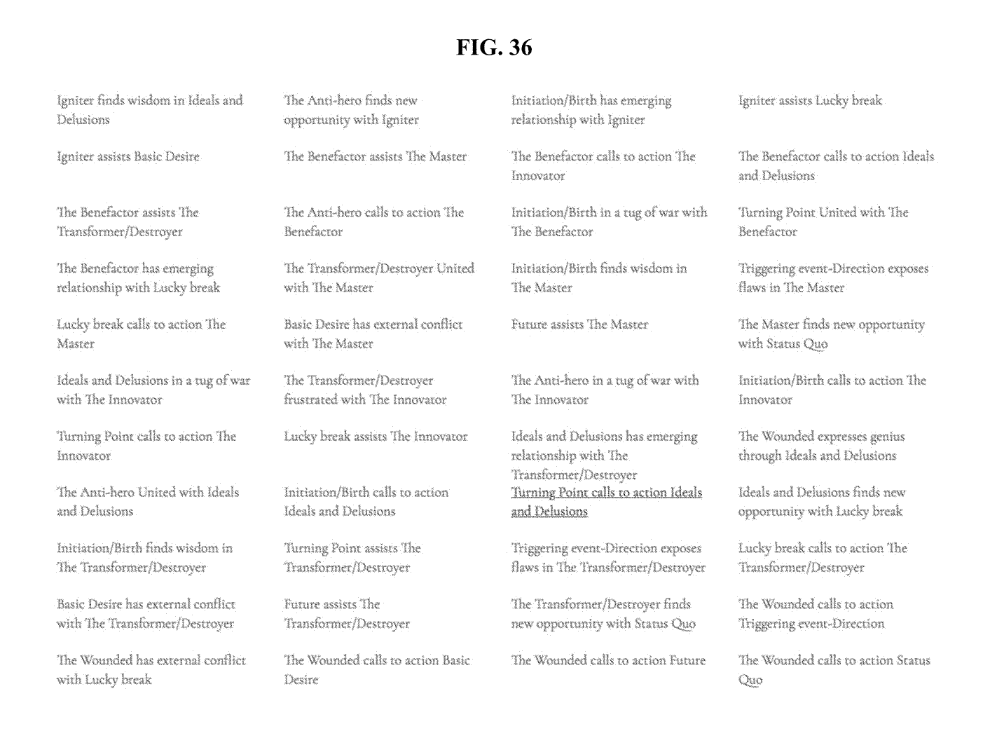

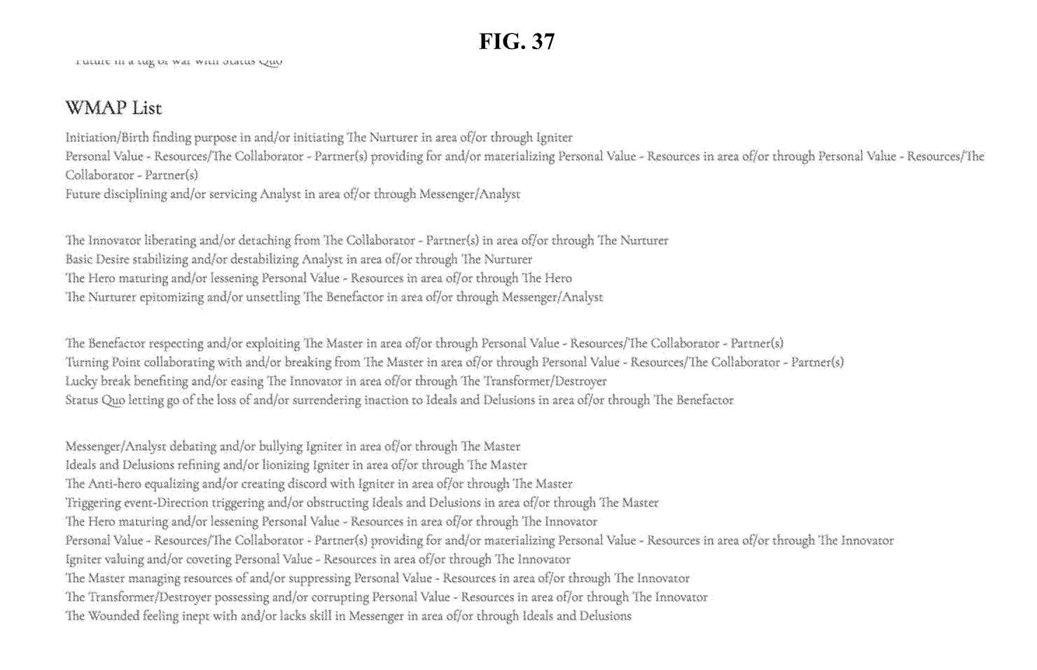

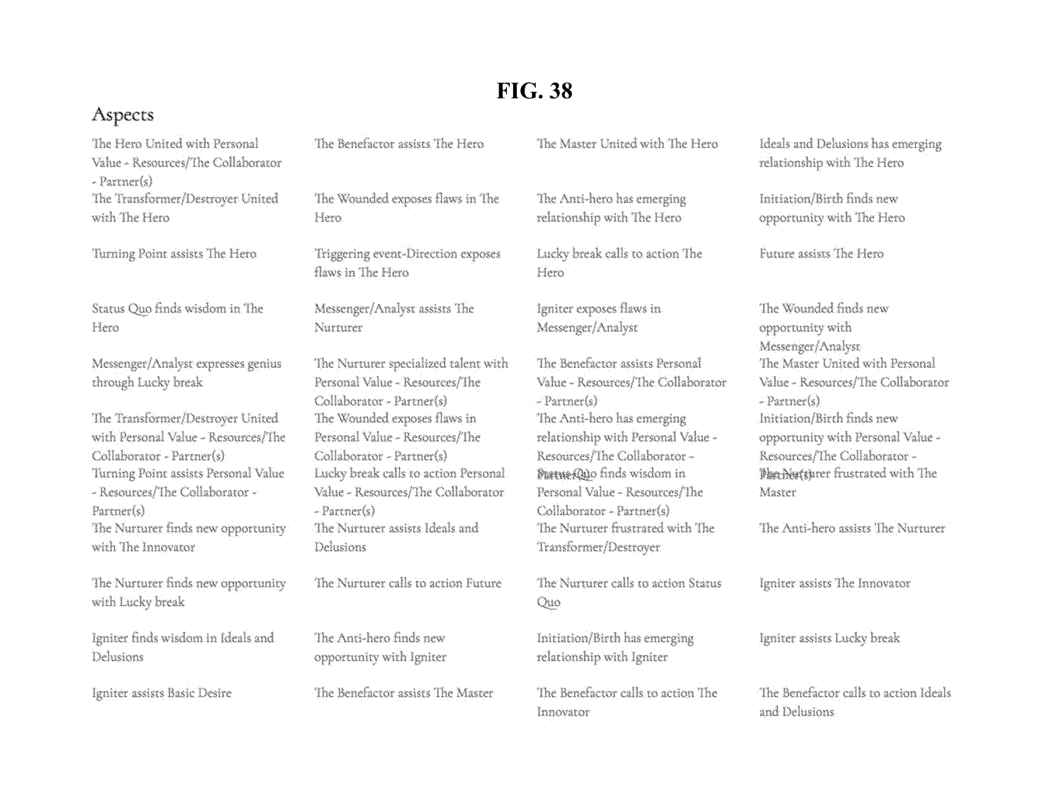

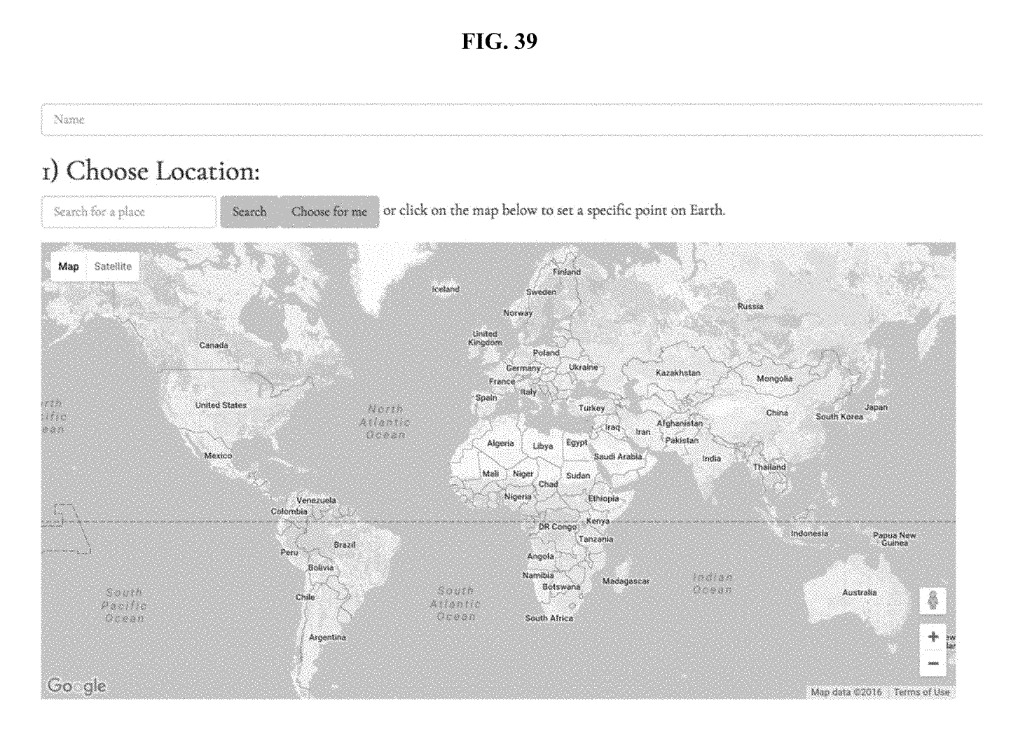

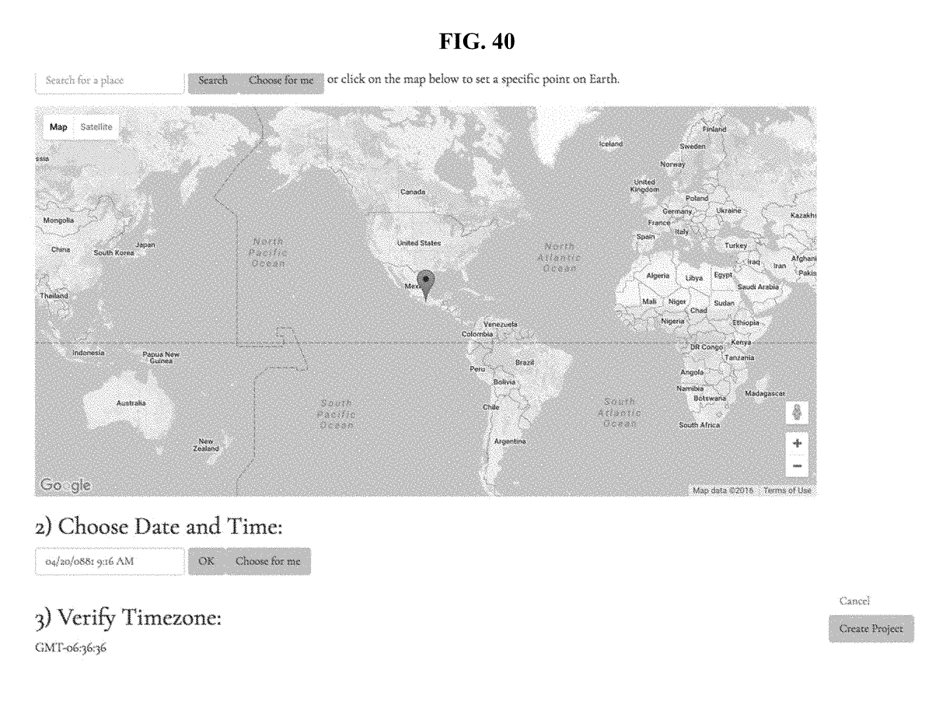

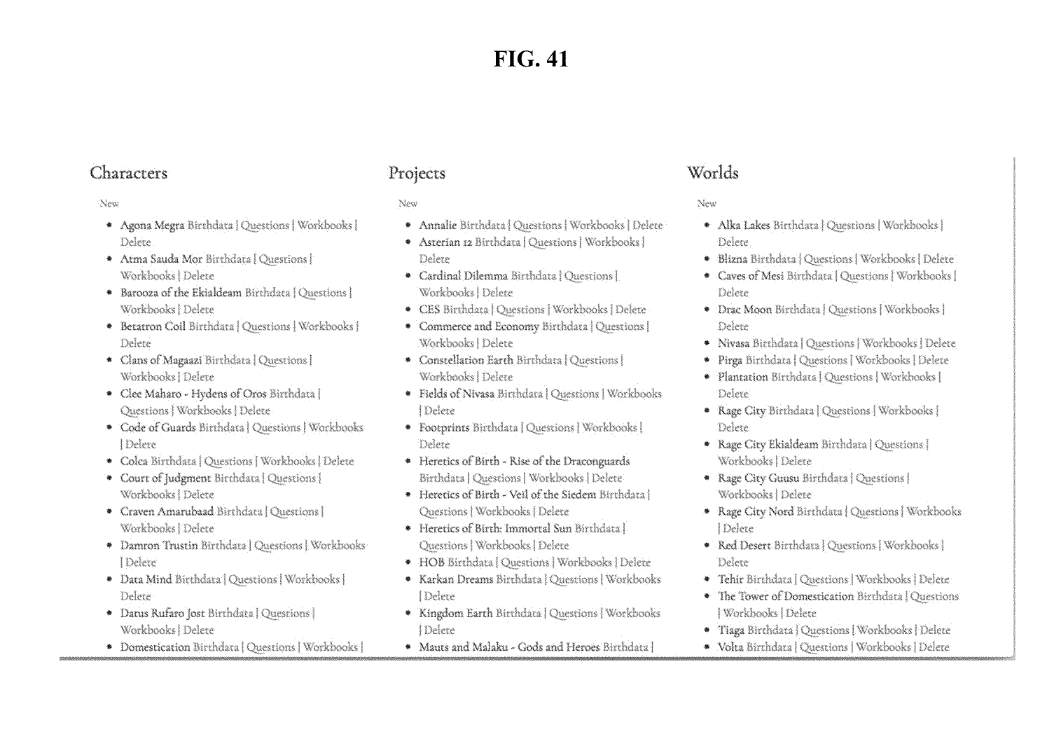

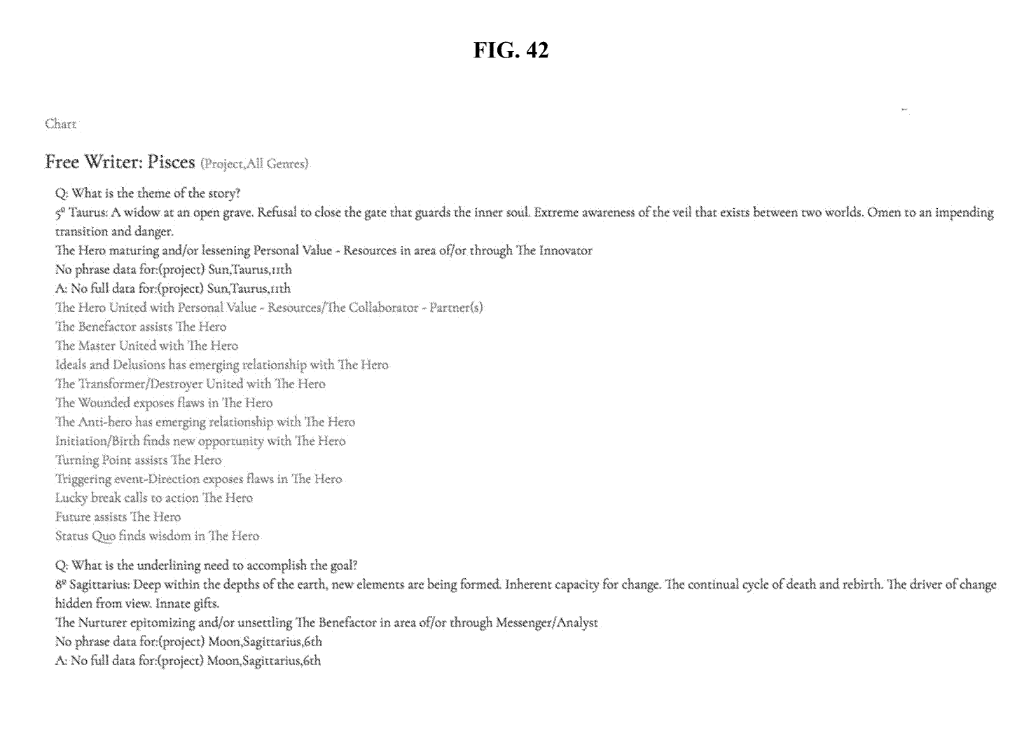

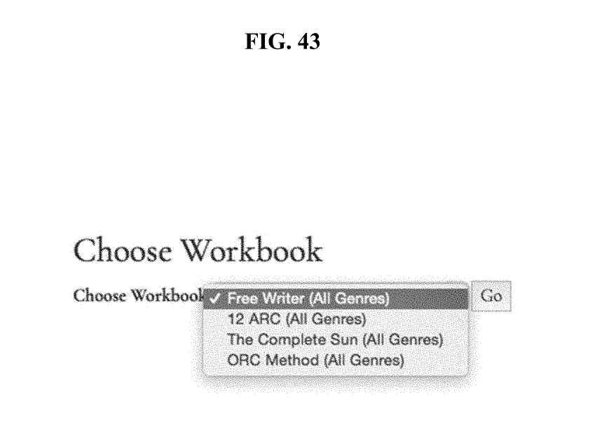

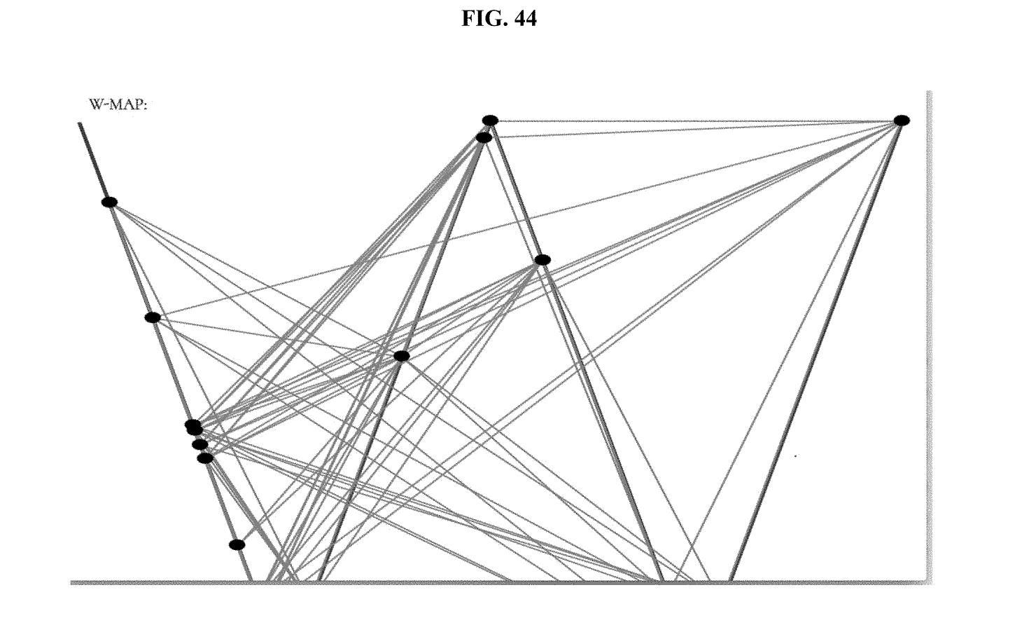

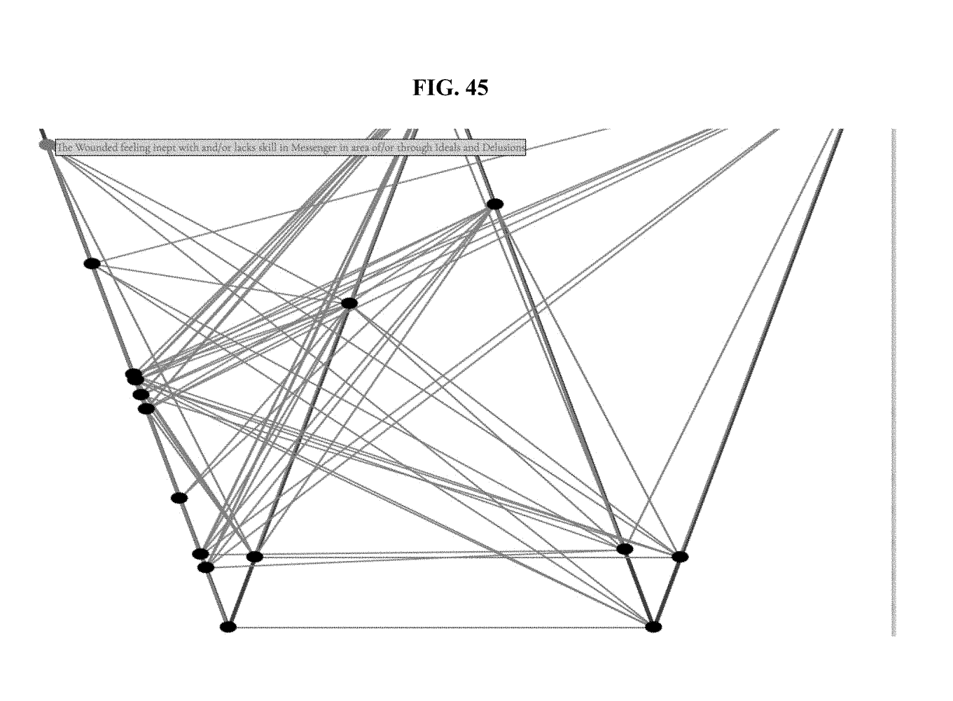

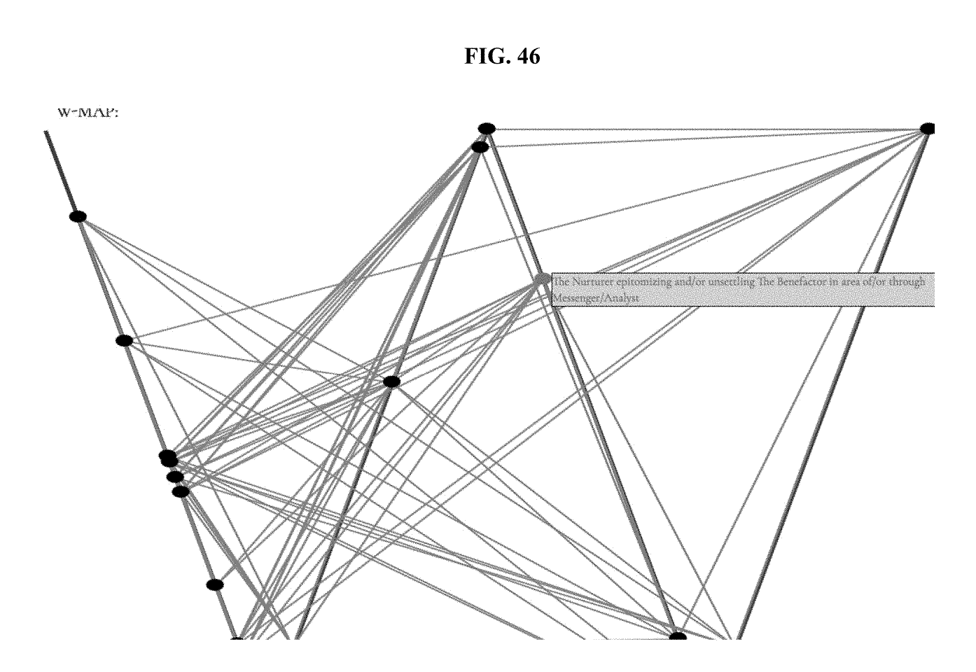

Planets in a sign in a house on the [invented PW story map are replaced by the character, place, thing or event they correlate to indicated in FIG. 27. The new map/chart shows a character (planet) performing an act on or with another character (sign) in or through the (house), a third character that has been delineated on the PW story map. The new PW story map can be read on multiple levels of awareness; through the astrological meaning and the meaning in the interaction between characters, place and things. Transits and aspects of planets in houses traveling through the map add yet another level to the understanding of the work (see, e.g., FIG. 27). In astrology, a transit is the continuous motion of the heavenly bodies around the astrological chart. Aspects are drawn between planets in signs (character relationships) within each chapter that indicate chapter-to-chapter connections between planets and signs (characters). Aspects are how the planets relate and interrelate with each other.

Similar charts are created for every character involved in the story by imputing the birth data to obtain their own unique chart. The archetypal data first provided for the novel is used to populate the chart of every new character, place, event or things related to the specific novel. The unique chart of the individual characters denotes that character's point of view in the story or work. New archetypal questions are created and answered by the author/writer when it has to do with development of the character's life or development of the world that is specific to the character or world.

According to some embodiments, a unique template, map, chart, and/or other tool may be created to aid specific industries and lifestyles using various software, hardware, or other technologies. For example, embodiments may be utilized in business, science/research, psychology, marketing, sales, finance and accounting, health/medicine/acupuncture and alternative medicine, every industry and professions, development of artificial intelligence, used to build new technology. Embodiments may be executed manually or through all current and future technologies such as the creation of web integrated software and applications, computer compatible software and applications, applications for user interface such as smart phones, notebooks, iPads, Google glass and all other personal computing technologies.

### Business, Marketing, Sales and Event Planning

To assist businesses, a business can create a traditional natal chart for the inception of the business, or a specific project, using the birth data, i.e., birth date, time and place of birth, of an event.

Archetypal questions are created that correspond to the astrological planets, nodes and asteroids and other celestial bodies.

For use with business or professional endeavors, questions and answers can be about company infrastructure, organizational structure, finance, employee, managers, vendors, administrators, healthcare, projects, leadership, events and all aspect of the business and company projects.

Templates and maps are created to identify the solutions needed for the completion of the project or business goals. The new astrological templates/maps are based on already used industry standards used to solve problems. Businesses can determine the interconnection and interrelations of their businesses. Gain a solid understanding of their strengths and weakness and how to bring balance to the business entity. Embodiments may provide solutions to pressing problems that plague the business such as the ability to identify specific areas that is unique to the business.

### Science and Research

Create a traditional birth/natal chart for the inception of the research or scientific project using birth date, time and place of birth.

Archetypal questions are created that correlate to the specific type of answers one needs to acquire in order to create the map and template design for the specific needs of the research. Answer archetypal questions that correspond to the astrological planets, nodes and asteroids and other celestial bodies.

For use with research protocol answers goals, design, methodology safety, data analysis, quality assurance, outcome, problems and risks anticipated, project management, ethical considerations, approvals, sample size, testing and all others requirements of research protocol, problem to be solved, finance, reception of work, investigator, participant, drug used, drug creation and performance and specific details about the research depending on the solution required.

Templates and maps are created to the solutions needed for the completion of the research. Embodiments may allow the researcher to determine the various components of the research and how it can be successfully managed. The tool can assist the researcher in determining the best avenue to accomplish their research goals as well as possibly find answers.

### Various Industries Such as Engineering, Manufacturing, Arts, Accounting, Finance, Etc.

Create a traditional birth/natal chart for the inception of the research or scientific project using birth date, time and place of birth.

Archetypal questions are created that correlate to the specific type of answers one needs to acquire in order to create the map and template design for the specific needs for each industry that is specific to their particular problems. Answer archetypal questions that correspond to the astrological planets, nodes and asteroids and other celestial bodies.

Templates and maps are created to the solutions needed for the completion of the research. Embodiments may allow the researcher to determine the various components of the research and how it can be successfully managed. The tool can assist the researcher in determining the best avenue to accomplish their research goals.

### Lifestyle & Entertainment

Create a traditional birth/natal chart for an entertainment storyboard (e.g., film storyboard, play storyboard, animation storyboard, storyboard for interactive media) using birth date, time and place of birth.

Archetypal questions are created that correlate to the specific type of answers one needs to acquire in order to create the map and template design for the specific needs of the research. Answer archetypal questions that correspond to the astrological planets, nodes and asteroids and other celestial bodies.

For use with life style planning and analysis. Answers to questions must include individual, things evens, goals, situations, career, family, friends, locations and all aspect of an individual's life. It allows for the understanding of specific interactions to their environment.

Templates and maps are created in order to find solutions needed for the problems of daily life and solve specific problems that point to specific people, events and goals of the user. Embodiments may allow the individual to understand how individuals, events, and places in their environment affect their lives. It provides insight about how those around them have and will affect their daily life, future, purpose, goals and ambitions and destiny. It provides specific solutions to everyday problems.

### The Ecliptic

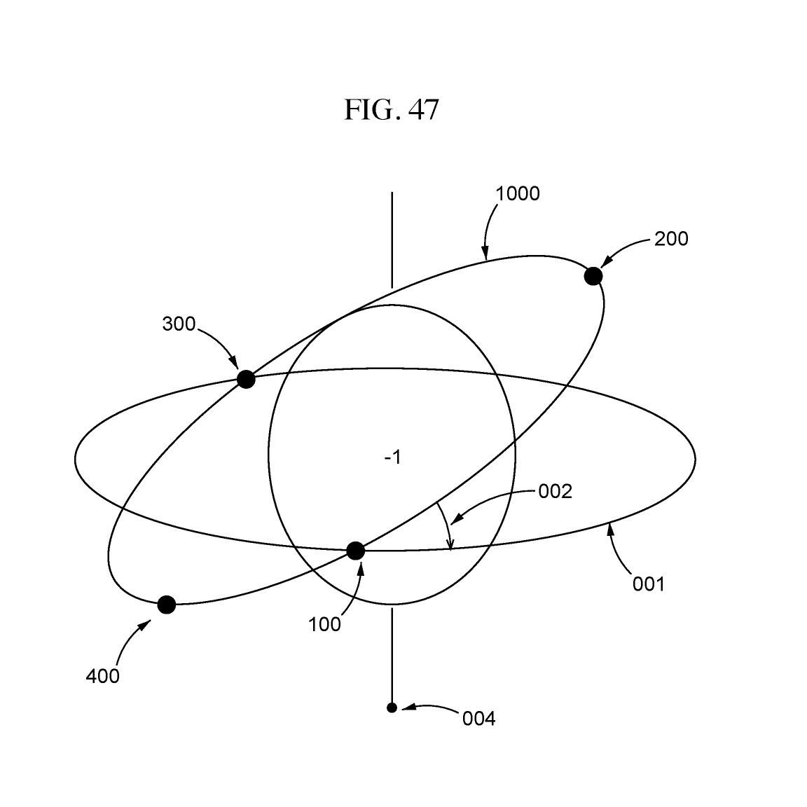

FIG. 47 indicates the ecliptic and the path of the sun through day and year from the reference point of the earth.

TABLE 4

| | |
|---|---|
| −1 or 0 | Earth, also represents the individual. |
| 001 | Celestial Equator of the Earth |
| 002 | 23.5 degrees is the angle by which the earth is tilted on its axis in its daily and |
| | yearly rotation around the Sun. It indicates the distance between the path of the |
| | Celestial Equator and the path of the Ecliptic. |
| 003 | Celestial North Pole of the Earth. |
| 004 | Celestial South Pole of the Earth. |
| 100 | The Vernal Equinox or Spring Equinox. The moment in the fall in the Northern |
| | hemisphere and spring in the Southern hemisphere where there is equal day and |
| | equal night. In the span of twenty-four hours, represents the time between 6 |
| | AM. It is called the Ascendant or Rising sign in the astrological chart. |
| 200 | The Summer Solstice is the time of year when the Sun is at its highest in the sky |
| | the longest. It is the longest day of the year. In the span of a twenty-four hour |
| | day, represents the time of Noon. Represents the North in the astrological chart. |
| | It is called the Imum Coeli in the astrological chart. |
| 300 | The Autumnal Equinox or Fall Equinox. The fall equinox represents equal day |
| | an equal night. In the span of a twenty-four hour day, represents the time of 6 |
| | PM. It is called the Descendant in the astrological chart. |
| 400 | The Winter Solstice. The point where the Sun is lowest in the sky represents the |
| | longest night of the year. In the span of a twenty-four hour day, represents the |
| | time of Midnight. Represents the south in the astrological signs. It is called |
| | Midheaven in the astrological chart. |
| 1000 | The Ecliptic, The apparent motion of the Sun around the earth through the year. |
| | It is also the apparent path of all planetary bodies around the Earth through the |
| | year. It is the location of the twelve astrological signs or constellations of the |
| | Zodiac. |

### Houses, Signs, Planets, and Cusps

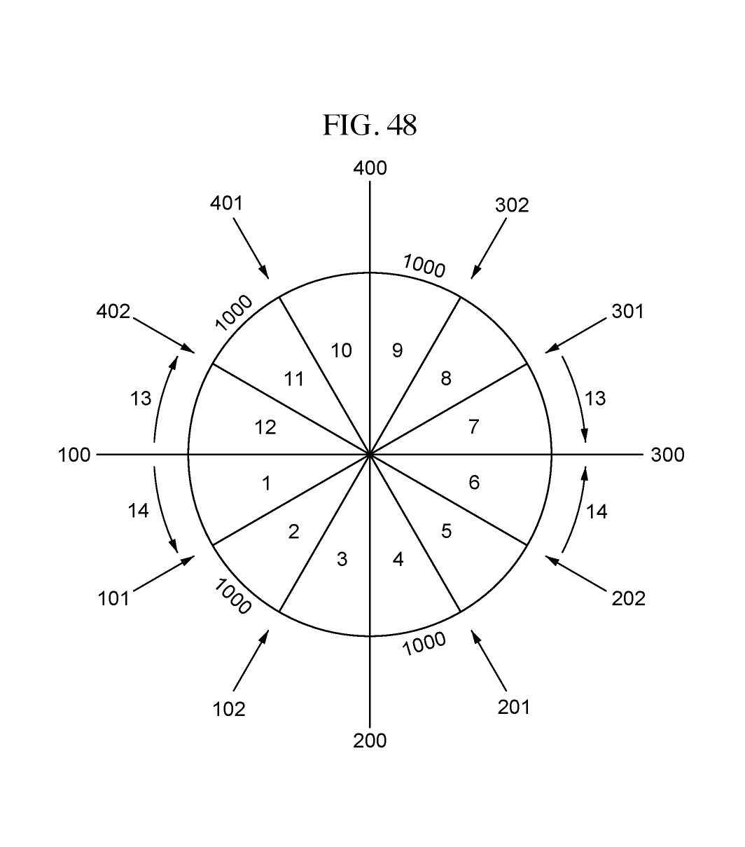

FIG. 48 indicates the astrological houses, signs, planets, and corresponding cusps.

TABLE 5

| | |
|---|---|
| −1 or 0 | Earth/You/The Individual/The center by which planets rotate. |
| 1 | It is the first house of the astrological chart. Corresponds to the planet of Mars |
| | and the sign of Aries. Takes the position of 0-30 degrees on the astrological |
| | sphere. The first house represents the persona, self, beginnings. |
| 2 | It is the second house of astrological chart. Corresponds to the planet of Venus |
| | and the sign of Taurus. Takes the position of 30-60 degrees. The second house |
| | represents income, value and pleasure. |
| 3 | The third house of the astrological chart. Corresponds to the planet of Mercury |
| | and the sign of Gemini. Takes the position of 60-90 degrees. The third house |
| | represents communications, siblings, neighbors. |
| 4 | The fourth house of the astrological chart. Corresponds to the planet and |
| | luminary called the Moon and the sign of Cancer. Takes the position around the |
| | ecliptic between 90-120 degrees. The fourth house represents original family, |
| | property, homeland etc. |
| 5 | The fifth house of the astrological chart. Corresponds to the astrological planet |
| | and astronomical luminary called the Sun and the sign of Leo. Takes the position |
| | around the ecliptic between 120-150 degrees. The fifth house represents |
| | creativity, children, romance etc. |
| 6 | The sixth house of the astrological chart. Corresponds to the planet of Mercury |
| | and the sign of Virgo. Takes the position around the ecliptic between 150-180 |
| | degrees. The sixth house represents service, health, everyday life etc. |
| 7 | The seventh house of the astrological chart. Corresponds to the planet of Venus |
| | and the sign of Libra. Takes the position around the ecliptic between 180-210 |
| | degrees. The seventh house represents partnerships in marriage and business, one |
| | and one relationships and foreign affairs. |
| 8 | The eighth house of the astrological chart. Corresponds to the planet of Pluto and |
| | the sign of Scorpio. Takes the position around the ecliptic between 210-240 |
| | degrees. The eighth house represents transformation, investments, sex etc. |
| 9 | The ninth house of the astrological chart. Corresponds to the planet of Jupiter |
| | and the sign of Sagittarius. Takes the position around the ecliptic between 240- |
| | 270 degrees. The ninth house represents higher education, international travel, |
| | philosophical mind etc. |
| 10 | The tenth house of the astrological chart. Corresponds to the planet Saturn and |
| | the sign Capricorn. Takes the position around the ecliptic between 270--300 |
| | degrees. The tenth house represents public acclaim, goals, authority, etc. |
| 11 | The eleventh house of the astrological chart. Correspond to the planet Uranus |
| | and the sign of Aquarius. Takes the position around the ecliptic between 300-330 |
| | degrees. The eleventh house represents allies and gains, community, inventions |
| | etc. |
| 12 | The twelfth house of the astrological chart. Corresponds to the planet Neptune |
| | and the sign of Pisces. Takes the position around the ecliptic between 230-260 |
| | degrees. The twelfth house represents the unknown, the collective unconscious, |
| | the spiritual etc. |
| 13 | Represents the literal and evolutionary path of the Sun and the Moon's nodes |
| | through the astrological chart. |

Component 100 represents Vernal Equinox or Spring Equinox. The moment in the fall in the Northern hemisphere and spring in the Southern hemisphere where there is equal day and equal night. In the span of twenty-four hours, represents the time between 6 AM. It is called the Ascendant or Rising sign in the astrological chart. In the astrological chart, the sign and its degree that is placed on the ascendant is acquired from the sign and degree that is rising on the east at the date, time and location of birth. All subsequent sign and degree of the zodiac populate the remaining cusps and houses in the chart based on the sign and degree on the ascendant (rising sign, or the cusp of the first house).

Component 101 represents cusps of the second house. The signs and degree that lands on the cusps of the second house indicates the planet and sign that control the second house area of life. This s different than the natural ruler and sign of the second house as indicated in numbers 2 of the astrological chart figure. It is based on the astrological snapshot of the date, time and location charted.

Component 102 represents cusps of the third house. The signs and degree that lands on the cusps of the third house indicates the planet and sign that control the third house area of life. This s different than the natural ruler and sign of the third house as indicated in numbers 3 of the figure. It is based on the astrological snapshot of the date, time and location charted.

Component 200 represents Summer Solstice is the time of year when the Sun is at its highest in the sky the longest. It is the longest day of the year. In the span of a twenty-four hour day, represents the time of Noon. Represents the North in the astrological chart. It is called the Imum Coeli in the astrological chart.

Component 200 also represents cusps of the fourth house. The signs and degree that lands on the cusps of the fourth house indicates the planet and sign that control the fourth house area of life. This s different than the natural ruler and sign of the fourth house as indicated in numbers 4 of the astrological chart figure. It is based on the astrological snapshot of the date, time and location charted.

Component 201 represents cusps of the fifth house. The signs and degree that lands on the cusps of the fifth house indicates the planet and sign that control the fifth house area of life. This s different than the natural ruler and sign of the fifth house as indicated in numbers 5 of the astrological chart figure. It is based on the astrological snapshot of the date, time and location charted.

Component 202 represents usps of the sixth house. The signs and degree that lands on the cusps of the sixth house indicates the planet and sign that control the sixth house area of life. This s different than the natural ruler and sign of the sixth house as indicated in numbers 6 of the astrological chart figure. It is based on the astrological snapshot of the date, time and location charted.

Component 300 represents Autumnal Equinox or Fall Equinox. The fall equinox represents equal day an equal night. In the span of a twenty-four hour day, represents the time of 6 PM. It is called the Descendant in the astrological chart.

Component 300 also represents cusps of the seventh house. The signs and degree that lands on the cusps of the seventh house indicates the planet and sign that control the seventh house area of life. This s different than the natural ruler and sign of the seventh house as indicated in numbers 7 of the astrological chart figure. It is based on the astrological snapshot of the date, time and location charted.

Component 301 represents cusps of the eighth house. The signs and degree that lands on the cusps of the eighth house indicates the planet and sign that control the eighth house area of life. This s different than the natural ruler and sign of the eighth house as indicated in numbers 8 of the astrological chart figure. It is based on the astrological snapshot of the date, time and location charted.

Component 302 represents cusps of the ninth house. The signs and degree that lands on the cusps of the ninth house indicates the planet and sign that control the ninth house area of life. This s different than the natural ruler and sign of the ninth house as indicated in numbers 9 of the astrological chart figure. It is based on the astrological snapshot of the date, time and location charted.

Component 400 represents Winter Solstice. The point where the Sun is lowest in the sky represents the longest night of the year. In the span of a twenty-four hour day, represents the time of Midnight. Represents the south in the astrological signs. It is called Midheaven in the astrological chart.

Component 400 also represents cusps of the tenth house. The signs and degree that lands on the cusps of the tenth house indicates the planet and sign that control the tenth house area of life. This s different than the natural ruler and sign of the tenth house as indicated in numbers 10 of the astrological chart figure. It is based on the astrological snapshot of the date, time and location charted.

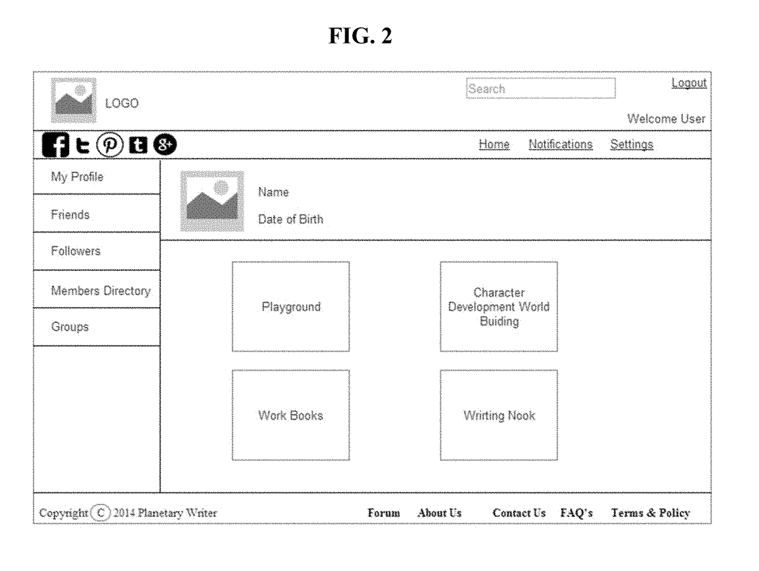

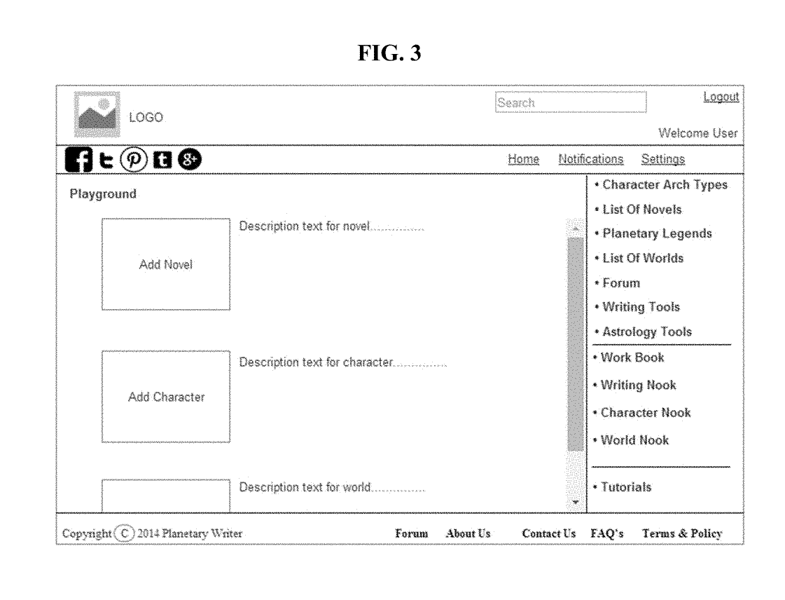

Component 401 represents cusps of the eleventh house. The signs and degree that lands on the cusps of the eleventh house indicates the planet and sign that control the eleventh house area of life. This s different than the natural ruler and sign of the eleventh house as indicated in numbers 11 of the astrological chart in FIG. 2. It is based on the astrological snapshot of the date, time and location charted.

Component 402 represents cusps of the twelfth house. The signs and degree that lands on the cusps of the twelfth house indicates the planet and sign that control the twelfth house area of life. This s different than the natural ruler and sign of the twelfth house as indicated in numbers 12 of the astrological chart figure. It is based on the astrological snapshot of the date, time and location charted.

Component 1000 represents the Ecliptic, the apparent motion of the Sun around the earth every 14 years. It is also the apparent path of all planetary bodies around the Earth through the year. It is the location of the twelve astrological signs or constellations of the Zodiac.

### “W” Storyboards

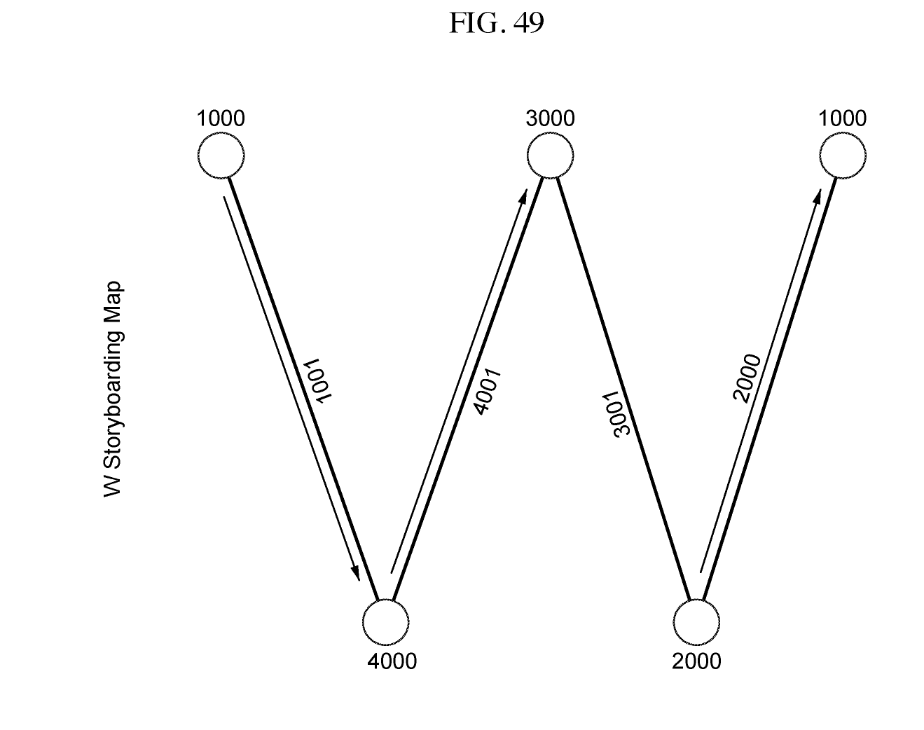

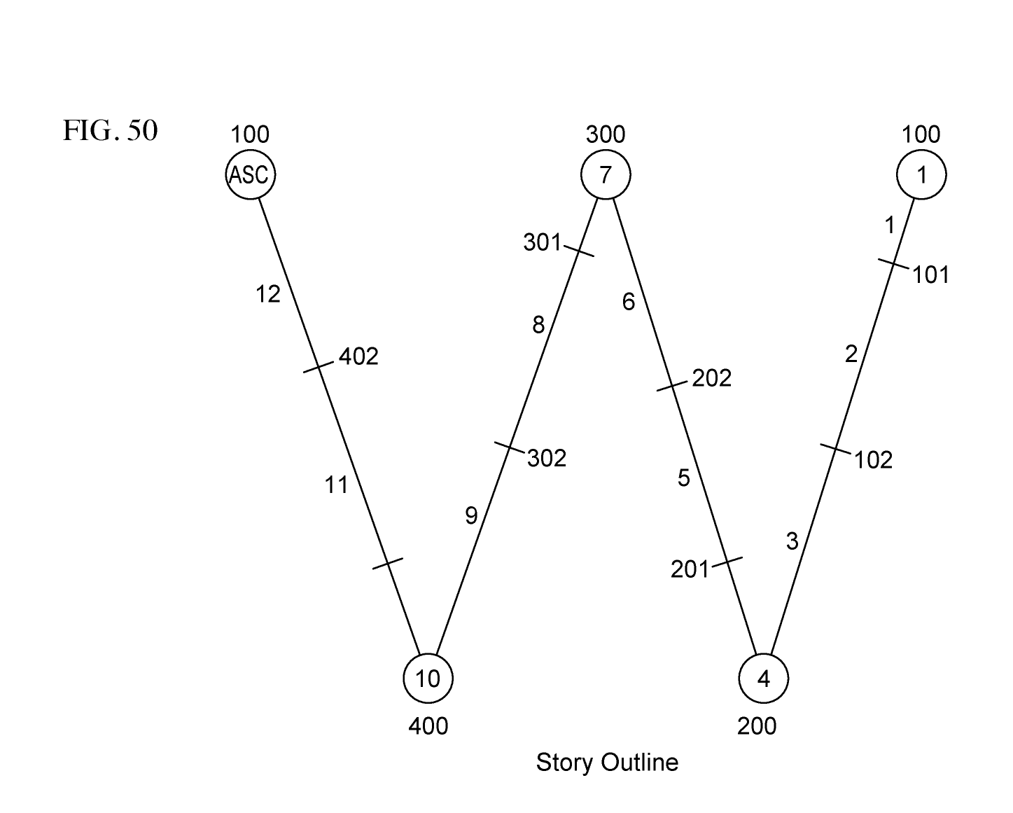

FIG. 49 illustrates a W storyboard map or structure in accordance with some embodiments.

TABLE 6

| Component | Context | Development | Hero's Journey (HJ) |
|---|---|---|---|
| 1000 | Act 1 | Triggering event. | Ordinary world, call |
| | | Outer event that | to action with a |
| | | triggers the action. | refusal to act. |
| | | Launches the book. | |
| 1001 | | Setting up the | Meeting the mentor, |
| | | problem. Epilogue | enemies, allies and |
| | | and inciting incident | obstacles. |
| 4000 | First turning point. | New information that | Crossing the thresh |
| | | changes perspective. | hold. Meeting the |
| | | Enlightenment | shadow |
| 4001 | | Recovering from the | Harrowing of the |
| | | problem. New ideas. | soul. Descent |
| 3000 | Act 2 | Second triggering | New rules, reversal, |
| | | event. Turning point. | second threshold |
| 3001 | | Problem deepens and | Physical and |
| | | worsens. | symbolic growth |
| 2000 | Act 3 | Second turning point. | Character changes |
| | | No hope, failure, | something internally. |
| | | lowest point. | Spiritual growth |
| | | Worst scenario that | |
| | | must be overcome. | |
| 2001 | | Epiphany moment. | |
| | | Resolving the | |
| | | problem | |
| 1000 | Resolution | | |

TABLE 7

| Planet | Archetypal Role to Novel | Corresponding Character |
|---|---|---|
| 1 | 1A | 1B |
| 2 | 2A | 2B |
| 3 | 3A | 3B |
| 4 | 4A | 4B |
| 5 | 5A | 5B |
| 6 | 6A | 6B |
| 7 | 7A | 7B |
| 8 | 8A | 8B |
| 9 | 9A | 9B |
| 10 | 10A | 10B |
| 11 | 11A | 11B |
| 12 | 12B | 12B |
| 13 | 13A | 13B |
| 14 | 14A | 14B |
| 15 | 15A | 15B |
| 16 | 16A | 16B |
| 17 | 17A | 17B |
| 18 | 18A | 18B |
| 19 | 19A | 19B |

A planetary legend may be used to transform the astrological chart.

TABLE 8

| | | Protagonist | Antagonist | |
|---|---|---|---|---|
| House | Description | Keywords | Keywords | User Action |
| 1 - | Describes the | Describes the | Describes the | The |
| Represents | archetypal | protagonist | antagonistic | user/writer |
| the 1^{st} | and | perspective of the | perspective of the | inputs the |
| house, the | psychological | planet Mars, sign of | planet Mars, sign of | name of the |
| planet Mars | purpose of | Aries and 1st house in | Aries and 1st house | character that |
| and the sign | the planet | order for the user to | in order for the user | corresponds |
| of Aries. | Mars for the | ascertain the nature of | to ascertain the | to the |
| | user | the character within | nature of the | archetype of |
| | | the story outline, | character within the | the planet |
| | | character | story outline, | Mars, Aries |
| | | development and | character | and the 1^{st} |
| | | world-building | development and | House. |
| | | templates. | world-building | |
| | | | templates. | |
| 2 - | Describes the | Describes the | Describes the | The |
| Represents | archetypal | protagonist | antagonistic | user/writer |
| the 2^{nd} | and | perspective of the | perspective of the | inputs the |
| house, the | psychological | planet Venus, sign of | planet Venus, sign of | name of the |
| planet | purpose of | Taurus and 2^{nd} house | Taurus and 2^{nd} house | character that |
| Venus and | the planet | in order for the user to | in order for the user | corresponds |
| the sign of | Venus. | ascertain the nature of | to ascertain the | to the |
| Taurus. | | the character within | nature of the | archetype of |
| | | the story outline, | character within the | the planet |
| | | character | story outline, | Venus, |
| | | development and | character | Taurus and |
| | | world-building | development and | the 2^{nd} |
| | | templates. | world-building | House. |
| | | | templates. | |
| 3 - | Describes the | Describes the | Describes the | The |
| Represents | archetypal | protagonist | antagonistic | user/writer |
| the 3^{rd} | and | perspective of the | perspective of the | inputs the |
| house, the | psychological | planet Mercury, sign | planet Mercury, sign | name of the |
| planet | purpose of | of Gemini and 3^{rd} | of Gemini and 3^{rd} | character that |
| Mercury and | the planet | house in order for the | house in order for the | corresponds |
| the sign of | Mercury. | user to ascertain the | user to ascertain the | to the |
| Gemini. | | nature of the character | nature of the | archetype of |
| | | within the story | character within the | the planet |
| | | outline, character | story outline, | Mercury, |
| | | development and | character | Gemini and |
| | | world-building | development and | the 3^{rd} |
| | | templates. | world-building | House. |
| | | | templates. | |
| 4 - | Describes the | Describes the | Describes the | The |
| Represents | archetypal | protagonist | antagonistic | user/writer |
| the 4^{th} | and | perspective of the | perspective of the | inputs the |
| house, the | psychological | planet Moon, sign of | planet Moon, sign of | name of the |
| planet Moon | purpose of | Cancer and 4^{th} house | Cancer and 4^{th} house | character that |
| and the sign | the planet | in order for the user to | in order for the user | corresponds |
| of Cancer. | Moon for the | ascertain the nature of | to ascertain the | to the |
| | user | the character within | nature of the | archetype of |
| | | the story outline, | character within the | the planet |
| | | character | story outline, | Moon, |
| | | development and | character | Cancer and |
| | | world-building | development and | the 4^{th} |
| | | templates. | world-building | House. |
| | | | templates. | |
| 5 - | Describes the | Describes the | Describes the | The |
| Represents | archetypal | protagonist | antagonistic | user/writer |
| the 5^{th} | and | perspective of the | perspective of the | inputs the |
| house, the | psychological | astrological planet | astrological planet | name of the |
| planet Sun | purpose of | Sun, sign of Leo and | Sun, sign of Leo and | character that |
| and the sign | the planet | 5^{th} house in order for | 5^{th} house in order for | corresponds |
| of Leo. | Sun. | the user to ascertain | the user to ascertain | to the |
| | | the nature of the | the nature of the | archetype of |
| | | character within the | character within the | the planet |
| | | story outline, | story outline, | Sun, Leo and |
| | | character | character | the 5^{th} |
| | | development and | development and | House. |
| | | world-building | world-building | |
| | | templates. | templates. | |
| 6 - | Describes the | Describes the | Describes the | The |
| Represents | archetypal | protagonist | antagonistic | user/writer |
| the 6^{th} | and | perspective of the | perspective of the | inputs the |
| house, the | psychological | planet Mercury, sign | planet Mercury, sign | name of the |
| planet | purpose of | of Virgo and 6^{th} house | of Virgo and 6^{th} | character that |
| Mercury and | the planet | in order for the user to | house in order for the | corresponds |
| the sign of | Mercury | ascertain the nature of | user to ascertain the | to the |
| Virgo. | | the character within | nature of the | archetype of |
| | | the story outline, | character within the | the planet |
| | | character | story outline, | Mercury, |
| | | development and | character | Virgo and the |
| | | world-building | development and | 6^{th} House. |
| | | templates. | world-building | |
| | | | templates. | |
| 7 - | Describes the | Describes the | Describes the | The |
| Represents | archetypal | protagonist | antagonistic | user/writer |
| the 7^{th} | and | perspective of the | perspective of the | inputs the |
| house, the | psychological | planet Venus, sign of | planet Venus, sign of | name of the |
| planet | purpose of | Libra and 7^{th} house in | Libra and 7^{th} house | character that |
| Venus and | the planet | order for the user to | in order for the user | corresponds |
| the sign of | Venus. | ascertain the nature of | to ascertain the | to the |
| Libra. | | the character within | nature of the | archetype of |
| | | the story outline, | character within the | the planet |
| | | character | story outline, | Venus, Libra |
| | | development and | character | and the 7^{th} |
| | | world-building | development and | House. |
| | | templates. | world-building | |
| | | | templates. | |
| 8 - | Describes the | Describes the | Describes the | The |
| Represents | archetypal | protagonist | antagonistic | user/writer |
| the 8^{th} | and | perspective of the | perspective of the | inputs the |
| house, the | psychological | planet Pluto, sign of | planet Pluto, sign of | name of the |
| planet Pluto | purpose of | Scorpio and 8^{th} house | Scorpio and 8^{th} house | character that |
| and the sign | the planet | in order for the user to | in order for the user | corresponds |
| of Scorpio. | Pluto | ascertain the nature of | to ascertain the | to the |
| | | the character within | nature of the | archetype of |
| | | the story outline, | character within the | the planet |
| | | character | story outline, | Pluto, |
| | | development and | character | Scorpio and |
| | | world-building | development and | the 8^{th} |
| | | templates. | world-building | House. |
| | | | templates. | |
| 9 - | Describes the | Describes the | Describes the | The |
| Represents | archetypal | protagonist | antagonistic | user/writer |
| the 9^{th} | and | perspective of the | perspective of the | inputs the |
| house, the | psychological | planet Jupiter, sign of | planet Jupiter, sign of | name of the |
| planet | purpose of | Sagittarius and 9^{th} | Sagittarius and 9^{th} | character that |
| Jupiter and | the planet | house in order for the | house in order for the | corresponds |
| the sign of | Jupiter | user to ascertain the | user to ascertain the | to the |
| Sagittarius. | | nature of the character | nature of the | archetype of |
| | | within the story | character within the | the planet |
| | | outline, character | story outline, | Jupiter, |
| | | development and | character | Sagittarius |
| | | world-building | development and | and the 9^{th} |
| | | templates. | world-building | House. |
| | | | templates. | |
| 10 - | Describes the | Describes the | Describes the | The |
| Represents | archetypal | protagonist | antagonistic | user/writer |
| the 10^{th} | and | perspective of the | perspective of the | inputs the |
| house, the | psychological | planet Saturn, sign of | planet Saturn, sign of | name of the |
| planet | purpose of | Capricorn and 10^{th} | Capricorn and 10^{th} | character that |
| Saturn and | the planet | house in order for the | house in order for the | corresponds |
| the sign of | Saturn | user to ascertain the | user to ascertain the | to the |
| Capricorn. | | nature of the character | nature of the | archetype of |
| | | within the story | character within the | the planet |
| | | outline, character | story outline, | Saturn, |
| | | development and | character | Capricorn |
| | | world-building | development and | and the 10^{th} |
| | | templates. | world-building | House. |
| | | | templates. | |
| 11 - | Describes the | Describes the | Describes the | The |
| Represents | archetypal | protagonist | antagonistic | user/writer |
| the 11^{th} | and | perspective of the | perspective of the | inputs the |
| house, the | psychological | planet Uranus, sign of | planet Uranus, sign | name of the |
| planet | purpose of | Aquarius and 11^{th} | of Aquarius and 11^{th} | character that |
| Uranus and | the planet | house in order for the | house in order for the | corresponds |
| the sign of | Uranus | user to ascertain the | user to ascertain the | to the |
| Aquarius. | | nature of the character | nature of the | archetype of |
| | | within the story | character within the | the planet |
| | | outline, character | story outline, | Uranus, |
| | | development and | character | Aquarius and |
| | | world-building | development and | the 11^{th} |
| | | templates. | world-building | House. |
| | | | templates. | |
| 12 - | Describes the | Describes the | Describes the | The |
| Represents | archetypal | protagonist | antagonistic | user/writer |
| the 12^{th} | and | perspective of the | perspective of the | inputs the |
| house, the | psychological | planet Neptune, sign | planet Neptune, sign | name of the |
| planet | purpose of | of Pisces and 12^{th} | of Pisces and 12^{th} | character that |
| Neptune and | the planet | house in order for the | house in order for the | corresponds |
| the sign of | Neptune | user to ascertain the | user to ascertain the | to the |
| Pisces. | | nature of the character | nature of the | archetype of |
| | | within the story | character within the | the planet |
| | | outline, character | story outline, | Neptune, |
| | | development and | character | Pisces and |
| | | world-building | development and | the 12^{th} |
| | | templates. | world-building | House. |
| | | | templates. | |
| 13 - | Describes the | Describes the | Describes the | The |
| Represents | archetypal | protagonist | antagonistic | user/writer |
| the Part of | and | perspective of the Part | perspective of the | inputs the |
| Fortune. | psychological | of Fortune in order for | Part of Fortune in | name of the |
| | purpose of | the user to ascertain | order for the user to | character that |
| | the Part of | the nature of the | ascertain the nature | corresponds |
| | Fortune | character within the | of the character | to the |
| | | story outline, | within the story | archetype of |
| | | character | outline, character | the Part of |
| | | development and | development and | Fortune. |
| | | world-building | world-building | |
| | | templates. | templates. | |
| 15 - | Describes the | Describes the | Describes the | The |
| Represents | archetypal | protagonist | antagonistic | user/writer |
| the asteroid | and | perspective of Eris in | perspective of Eris in | inputs the |
| Eris. | psychological | order for the user to | order for the user to | name of the |
| | purpose of | ascertain the nature of | ascertain the nature | character that |
| | Eris | the character within | of the character | corresponds |
| | | the story outline, | within the story | to the |
| | | character | outline, character | archetype of |
| | | development and | development and | Eris. |
| | | world-building | world-building | |
| | | templates. | templates. | |
| 16 - | Describes the | Describes the | Describes the | The |
| Represents | archetypal | protagonist | antagonistic | user/writer |
| Chiron. | and | perspective of Chiron | perspective of Chiron | inputs the |
| | psychological | in order for the user to | in order for the user | name of the |
| | purpose of | ascertain the nature of | to ascertain the | character that |
| | Chiron | the character within | nature of the | corresponds |
| | | the story outline, | character within the | to the |
| | | character | story outline, | archetype of |
| | | development and | character | Chiron. |
| | | world-building | development and | |
| | | templates. | world-building | |
| | | | templates. | |
| 17 - | Describes the | Describes the | Describes the | The |
| Represents | archetypal | protagonist | antagonistic | user/writer |
| the North | and | perspective of the | perspective of the | inputs the |
| Node. | psychological | North Node in order | North Node in order | name of the |
| | purpose of | for the user to | for the user to | character that |
| | the North | ascertain the nature of | ascertain the nature | corresponds |
| | Node | the character within | of the character | to the |
| | | the story outline, | within the story | archetype of |
| | | character | outline, character | the North |
| | | development and | development and | Node. |
| | | world-building | world-building | |
| | | templates. | templates. | |
| 18 - | Describes the | Describes the | Describes the | The |
| Represents | archetypal | protagonist | antagonistic | user/writer |
| the South | and | perspective of the | perspective of the | inputs the |
| Node. | psychological | South Node in order | South Node in order | name of the |
| | purpose of | for the user to | for the user to | character that |
| | the planet | ascertain the nature of | ascertain the nature | corresponds |
| | South Node | the character within | of the character | to the |
| | | the story outline, | within the story | archetype of |
| | | character | outline, character | the South |
| | | development and | development and | Node. |
| | | world-building | world-building | |
| | | templates. | templates. | |
| 19 - | Describes the | Describes the | Describes the | The |
| Represents | archetypal | protagonist | antagonistic | user/writer |
| an | and | perspective of an | perspective of an | inputs the |
| astronomical | psychological | astronomical body, | astronomical body, | name of the |
| body, sign | purpose an | sign or house in order | sign or house in | character that |
| or house. | astronomical | for the user to | order for the user to | corresponds |
| | body, sign or | ascertain the nature of | ascertain the nature | to the |
| | house. | the character within | of the character | archetype of |
| | | the story outline, | within the story | an |
| | | character | outline, character | astronomical |
| | | development and | development and | body, sign or |
| | | world-building | world-building | house. |
| | | templates. | templates. | |

Component 1 is the twelfth section or chapter of the novel. It is the 1^{st} house of the astrological chart. The 1^{st} house is naturally ruled by the planet Mars and its corresponding sign Aries. The character that correlates to Mars and Aries is the character that controls the area of life of the 1^{st} house or twelfth section/chapter. Planets in degrees in signs that reside in the 1^{st} house that is based on the astrological chart used to outline the novel/W-storyboarding map, shows actions taking place by the characters that corresponds to those planets and signs. If there is/are no planets in the 1^{st} house based on the chart used, then the sign/character that is on the cusps of the 1^{st} (100) house is in control of the action and activity of the 1^{st} house.

Component 2 is the eleventh section or chapter of the novel. It is the 2^{nd} house of the astrological chart. The 2^{nd} house is naturally ruled by the planet Venus and its corresponding sign Taurus. The character that correlates to Venus and Taurus is the character that controls the area of life of the 2^{nd} house or eleventh section/chapter. Planets in degrees in signs that reside in the 2^{nd} house that is based on the astrological chart used to outline the novel/W-storyboarding map, shows actions taking place by the characters that corresponds to those planets and signs. If there is/are no planets in the 2^{nd} house based on the chart used, then the sign/character that is on the cusps of the 2^{nd} (101) house is in control of the action and activity of the 2^{nd} house.

Component 3 is the tenth section or chapter of the novel. It is the 3^{rd} house of the astrological chart. The 3^{rd} house is naturally ruled by the planet Mercury and its corresponding sign Gemini. The character that correlates to Mercury and Gemini is the character that controls the area of life of the 3^{rd} house or tenth section/chapter. Planets in degrees in signs that reside in the 3^{rd} house that is based on the astrological chart used to outline the novel/W-storyboarding map, shows actions taking place by the characters that corresponds to those planets and signs. If there is/are no planets in the 3^{rd} house based on the chart used, then the sign/character that is on the cusps of the 3^{rd} (102) house is in control of the action and activity of the 3^{rd} house.

Component 4 is the ninth section or chapter of the novel. It is the 4^{th} house of the astrological chart. The 4^{th} house is naturally ruled by the planet Moon and its corresponding sign Cancer. The character that correlates to Moon and Cancer is the character that controls the area of life of the 4^{th} house or ninth section/chapter. Planets in degrees in signs that reside in the 4^{th} house that is based on the astrological chart used to outline the novel/W-storyboarding map, shows actions taking place by the characters that corresponds to those planets and signs. If there is/are no planets in the 9^{th} house based on the chart used, then the sign/character that is on the cusps of the 9^{th} (200) house is in control of the action and activity of the 9^{th} house.

Component 5 is the eighth section or chapter of the novel. It is the 5^{th} house of the astrological chart. The 5^{th} house is naturally ruled by the planet Sun and its corresponding sign Leo. The character that correlates to Sun and Leo is the character that controls the area of life of the 5^{th} house or eighth section/chapter. Planets in degrees in signs that reside in the 11^{th} house that is based on the astrological chart used to outline the novel/W-storyboarding map, shows actions taking place by the characters that corresponds to those planets and signs. If there is/are no planets in the 5^{th} house based on the chart used, then the sign/character that is on the cusps of the 5^{th} (201) house is in control of the action and activity of the 5^{th} house.

Component 6 is the seventh section or chapter of the novel. It is the 6^{th} house of the astrological chart. The 6^{th} house is naturally ruled by the planet Mercury and its corresponding sign Virgo. The character that correlates to Mercury and Virgo is the character that controls the area of life of the 6^{th} house or seventh section/chapter. Planets in degrees in signs that reside in the 6^{th} house that is based on the astrological chart used to outline the novel/W-storyboarding map, shows actions taking place by the characters that corresponds to those planets and signs. If there is/are no planets in the 6^{th} house based on the chart used, then the sign/character that is on the cusps of the 6^{th} (202) house is in control of the action and activity of the 6^{th} house.

Component 7 is the sixth section or chapter of the novel. It is the 7^{th} house of the astrological chart. The 7^{th} house is naturally ruled by the planet Venus and its corresponding sign Libra. The character that correlates to Venus and Libra is the character that controls the area of life of the 7^{th} house or sixth section/chapter. Planets in degrees in signs that reside in the 11^{th} house that is based on the astrological chart used to outline the novel/W-storyboarding map, shows actions taking place by the characters that corresponds to those planets and signs. If there is/are no planets in the 7^{th} house based on the chart used, then the sign/character that is on the cusps of the 7^{th} (300) house is in control of the action and activity of the 7^{th} house.

Component 8 is the fifth section or chapter of the novel. It is the 8^{th} house of the astrological chart. The 8^{th} house is naturally ruled by the planet Pluto and its corresponding sign Scorpio. The character that correlates to Pluto and Scorpio is the character that controls the area of life of the 8^{th} house or fifth section/chapter. Planets in degrees in signs that reside in the 8^{th} house that is based on the astrological chart used to outline the novel/W-storyboarding map, shows actions taking place by the characters that corresponds to those planets and signs. If there is/are no planets in the 8^{th} house based on the chart used, then the sign/character that is on the cusps of the 8^{th} (301) house is in control of the action and activity of the 8^{th} house.

Component 9 is the fourth section or chapter of the novel. It is the 9^{th} house of the astrological chart. The 9^{th} house is naturally ruled by the planet Jupiter and its corresponding sign Sagittarius. The character that correlates to Jupiter and Sagittarius is the character that controls the area of life of the 9^{th} house or fourth section/chapter. Planets in degrees in signs that reside in the 9^{th} house that is based on the astrological chart used to outline the novel/W-storyboarding map, shows actions taking place by the characters that corresponds to those planets and signs. If there is/are no planets in the 9^{th} house based on the chart used, then the sign/character that is on the cusps of the 9^{th} (302) house is in control of the action and activity of the 9^{th} house.

Component 10 is the third section or chapter of the novel. It is the 10^{th} house of the astrological chart. The 10^{th} house is naturally ruled by the planet Saturn and its corresponding sign Capricorn. The character that correlates to Saturn and Capricorn is the character that controls the area of life of the 10^{th} house or third section/chapter. Planets in degrees in signs that reside in the 10^{th} house that is based on the astrological chart used to outline the novel/W-storyboarding map, shows actions taking place by the characters that corresponds to those planets and signs. If there is/are no planets in the 10^{th} house based on the chart used, then the sign/character that is on the cusps of the 10^{th} (400) house is in control of the action and activity of the 10^{th} house.

Component 11 is the second section or chapter of the novel. It is the 11^{th} house of the astrological chart. The 11^{th} house is naturally ruled by the planet Uranus and its corresponding sign Aquarius. The character that correlates to Uranus and Aquarius is the character that controls the area of life of the 11^{th} house or second section/chapter. Planets in degrees in signs that reside in the 11^{th} house that is based on the astrological chart used to outline the novel/W-storyboarding map, shows actions taking place by the characters that corresponds to those planets and signs. If there is/are no planets in the 11^{th} house based on the chart used, then the sign/character that is on the cusps of the 11^{th} (401) house is in control of the action and activity of the 11^{th} house.

Component 12 is the first section or chapter of the novel. It is the 12^{th} house of the astrological chart. The 12^{th} house is naturally ruled by the planet Neptune and its corresponding sign Pisces. The character that correlates to Neptune and Pisces is the character that controls the area of life of the 12^{th} house or first section/chapter. Planets in degrees in signs that reside in the 12^{th} house that is based on the astrological chart used to outline the novel/W-storyboarding map, shows actions taking place by the characters that corresponds to those planets and signs. If there is/are no planets in the 12^{th} house based on the chart used, then the sign/character that is on the cusps of the 12^{th} (402) house is in control of the action and activity of the 12^{th} house.

Component 100 is the first trigger of awakening in the story for the character. In the astrological chart, it is the sign, degree and character that reside on the ascendant and marks the cusps of the first house. Indicates the beginning of the novel on the W-storyboarding Map

Component 402 is the end of the first section or chapter of the novel. In the astrological chart of the novel, it is the cusps of the 12^{th} house. The sign, degree and corresponding character that land on the cusp of the 12^{th} house is the major influence on the nature and the quality of action that is indicated by the 12^{th} house or first section/chapter of the novel.

Component 401 is the end of the second section or chapter of the novel. In the astrological chart of the novel, it is the cusps of the 11^{th} house. The sign, degree and corresponding character that land on the cusp of the 11^{th} house is the major influence on the nature and the quality of action that is indicated by the 11^{th} house or second section/chapter of the novel.

Component 400 is the end the third section/chapter. It is when the character crosses the thresh hold and decides to take on the challenge of the plot. In the astrological chart, it is the sign, degree and character that reside on the Midheaven and marks the cusps of the fourth house. Indicates the goal and second trigger of the novel or for the character on the W-storyboarding Map

Component 302 is the end of the fourth section or chapter of the novel. In the astrological chart of the novel, it is the cusps of the 9^{th} house. The sign, degree and corresponding character that land on the cusp of the 9^{th} house is the major influence on the nature and the quality of action that is indicated by the 9^{th} house or fourth section/chapter of the novel.

Component 301 is the end of the fifth section or chapter of the novel. In the astrological chart of the novel, it is the cusps of the 8^{th} house. The sign, degree and corresponding character that land on the cusp of the 8^{th} house is the major influence on the nature and the quality of action that is indicated by the 8^{th} house or fifth section/chapter of the novel.

Component 300 is the he end of the sixth section/chapter of the novel. Marks the turning point in the story for the character. In the astrological chart, it is the sign, degree and character that reside on the descendant and marks the cusps of the 7^{th} house. Indicates the new beginning of the novel on the W-storyboarding Map

Component 202 is the end of the seventh section or chapter of the novel. In the astrological chart of the novel, it is the cusps of the 6^{th} house. The sign, degree and corresponding character that land on the cusp of the 6^{th} house is the major influence on the nature and the quality of action that is indicated by the 6^{th} house or seventh section/chapter of the novel.

Component 201 is the end of the eighth section or chapter of the novel. In the astrological chart of the novel, it is the cusps of the 5^{th} house. The sign, degree and corresponding character that land on the cusp of the 5^{th} house is the major influence on the nature and the quality of action that is indicated by the 5^{th} house or eighth section/chapter of the novel.

Component 200 is the end of the ninth section or chapter of the novel. Lowest point in the story for the character. In the astrological chart, it is the sign, degree and character that reside on the Imum Coeli and marks the cusps of the 4^{th} house. Indicates the final challenge of the novel on the W-storyboarding Map

Component 102 is the end of the tenth section or chapter of the novel. In the astrological chart of the novel, it is the cusps of the 3^{rd} house. The sign, degree and corresponding character that land on the cusp of the 3^{rd} house is the major influence on the nature and the quality of action that is indicated by the 3^{rd} house or tenth section/chapter of the novel.

Component 101 is the end of the eleventh section or chapter of the novel. In the astrological chart of the novel, it is the cusps of the 2^{nd} house. The sign, degree and corresponding character that land on the cusp of the 2^{nd} house is the major influence on the nature and the quality of action that is indicated by the 2^{nd} house or eleventh section/chapter of the novel.

The W-Storyboarding Map may be superimposed with the astrological chart.

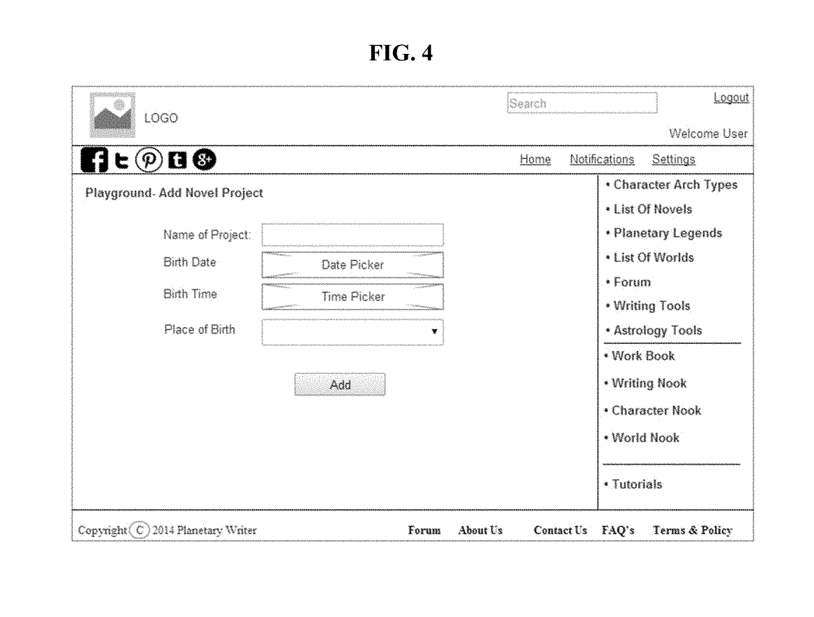

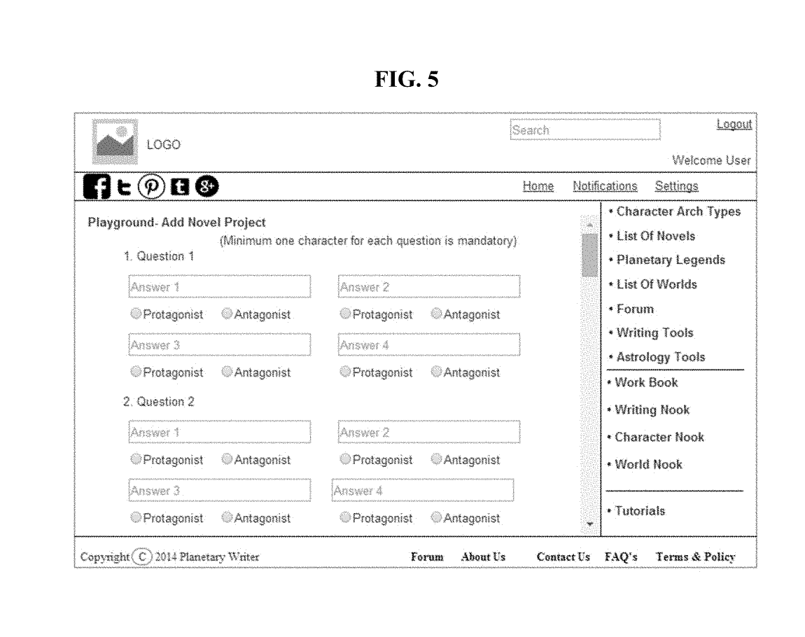

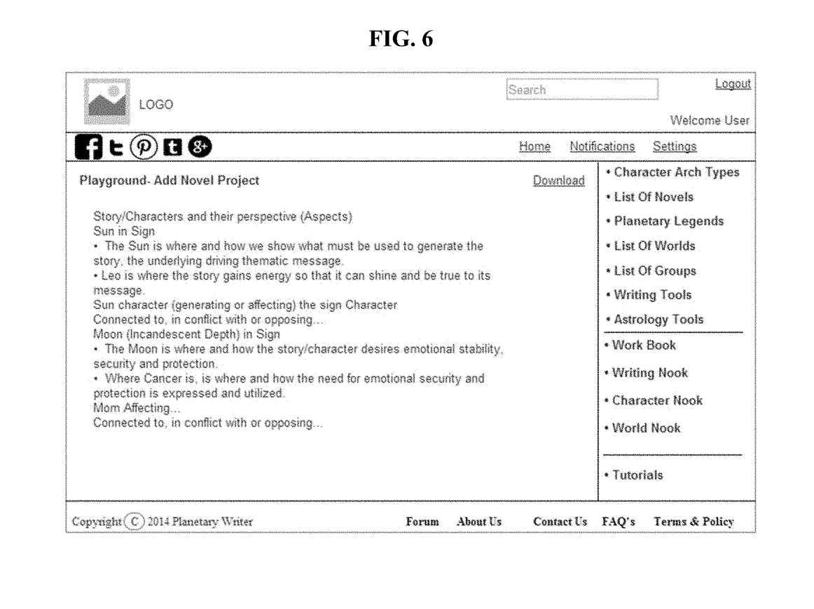

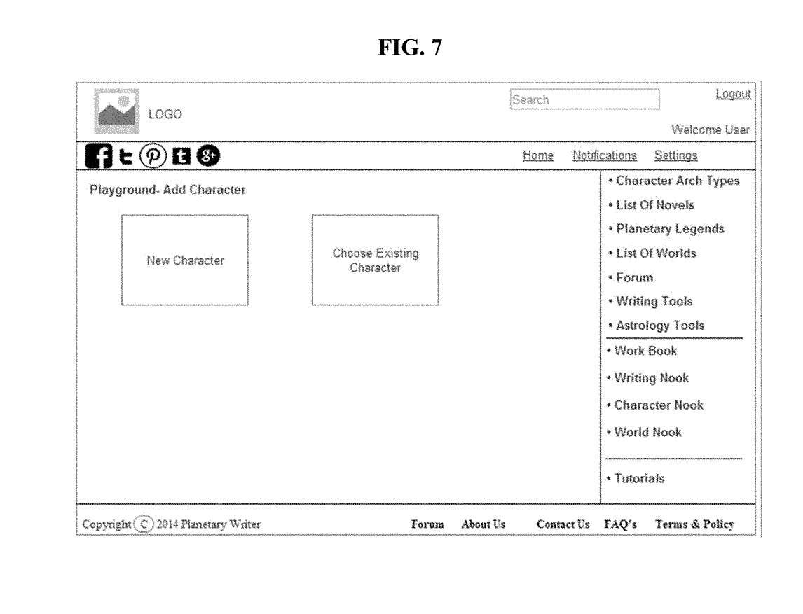

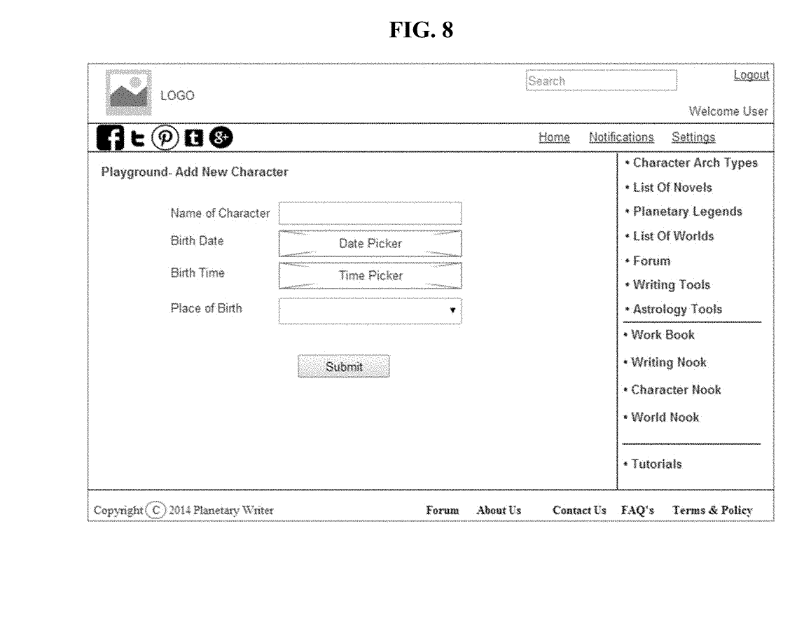

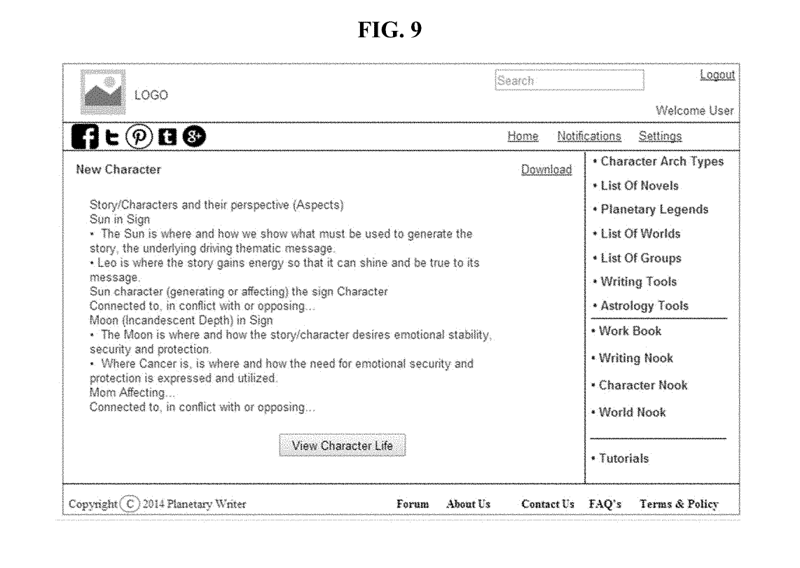

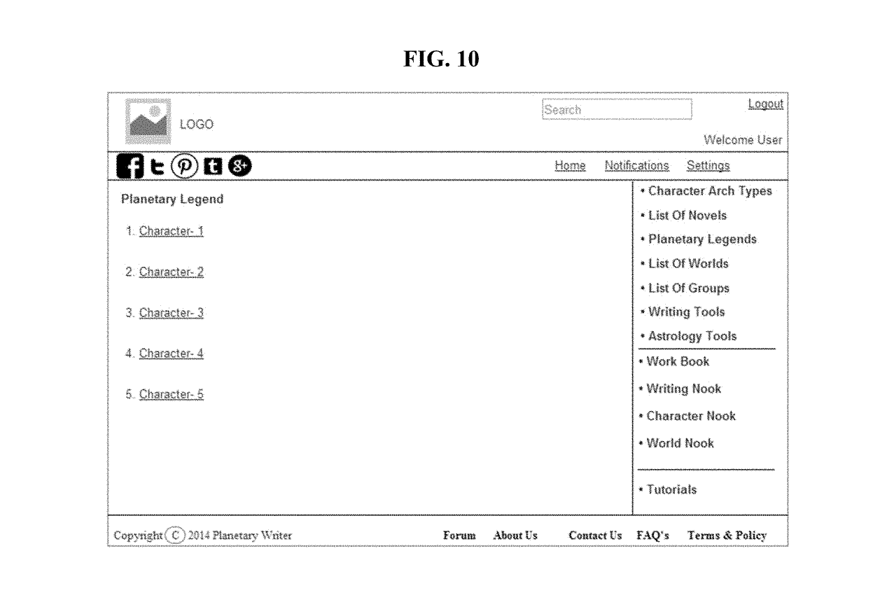

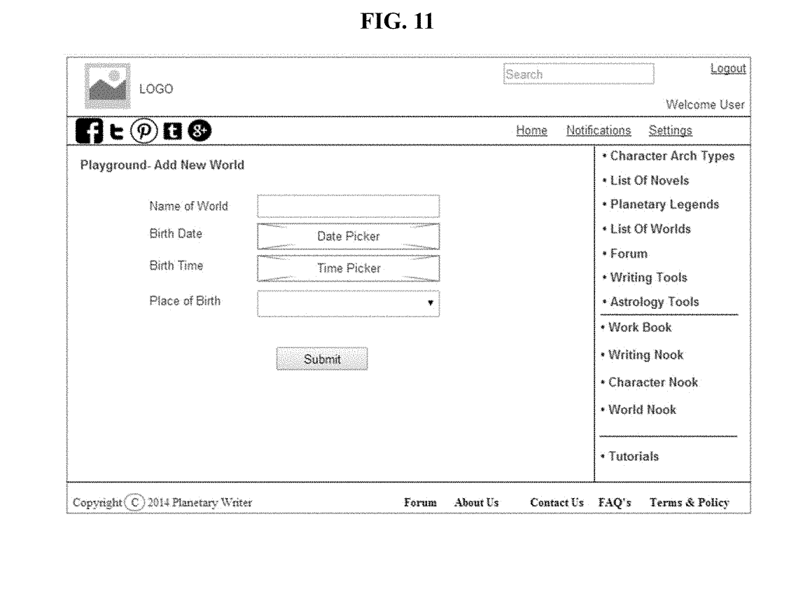

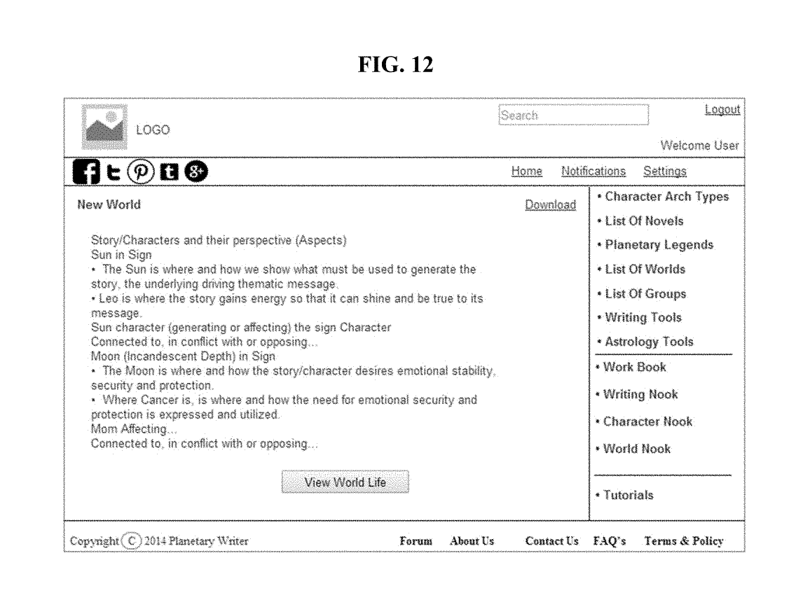

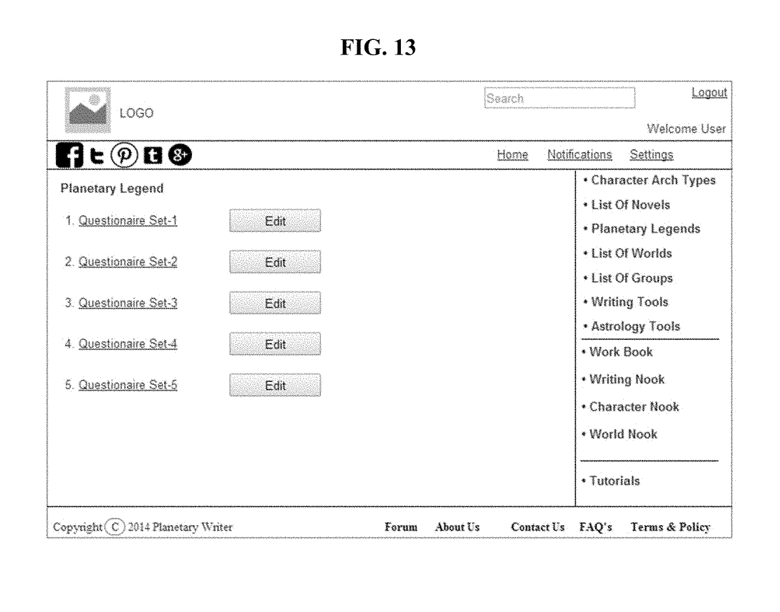

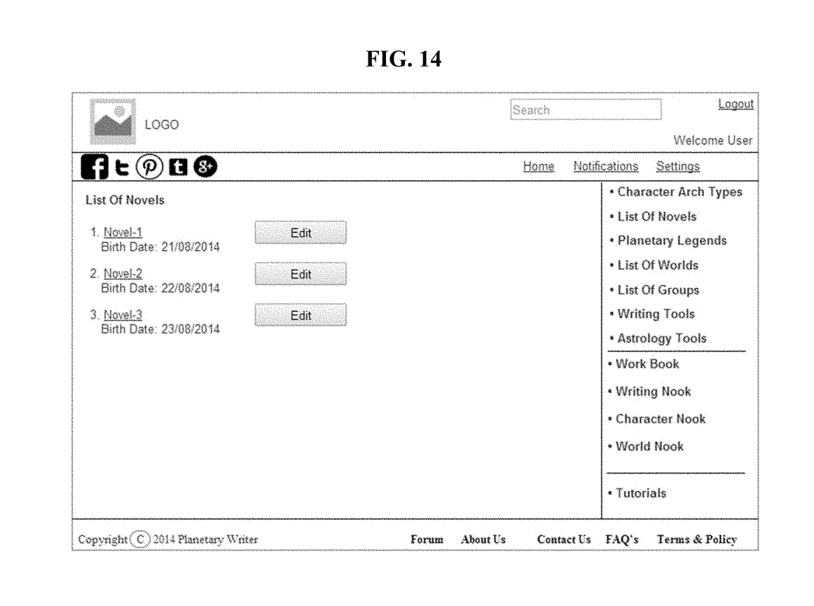

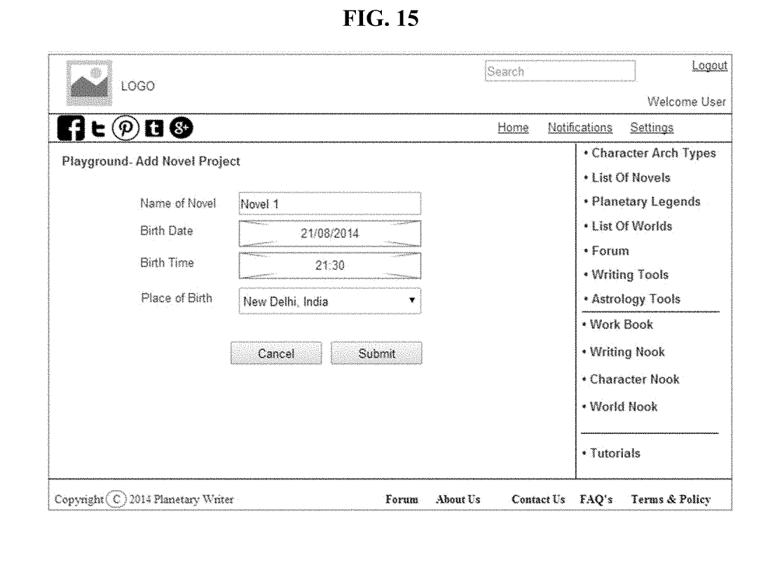

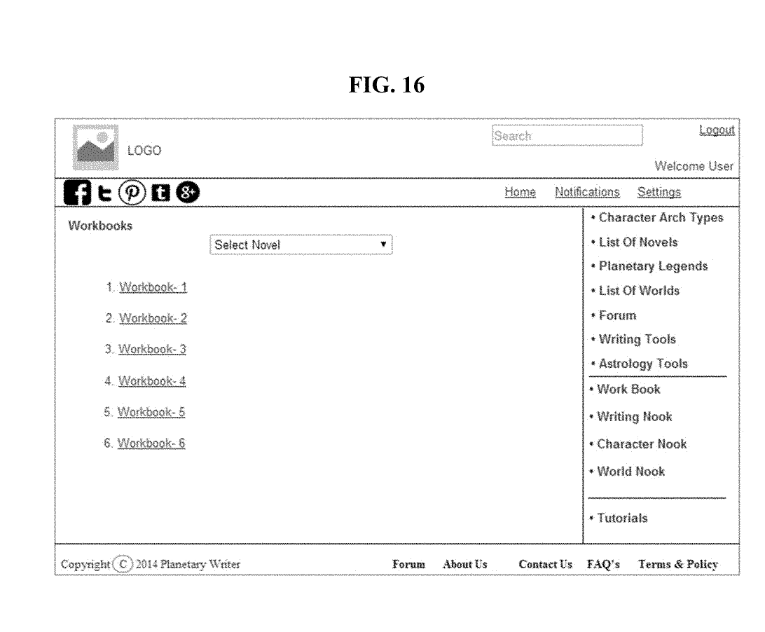

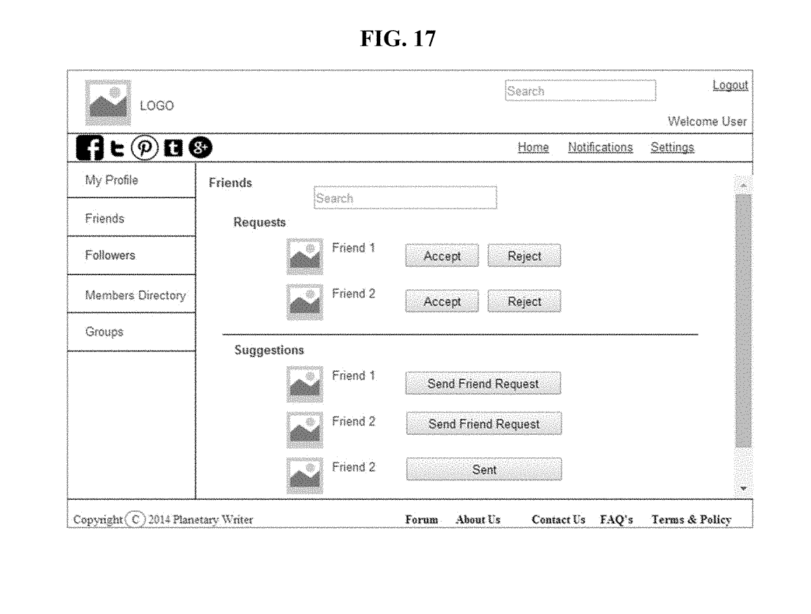

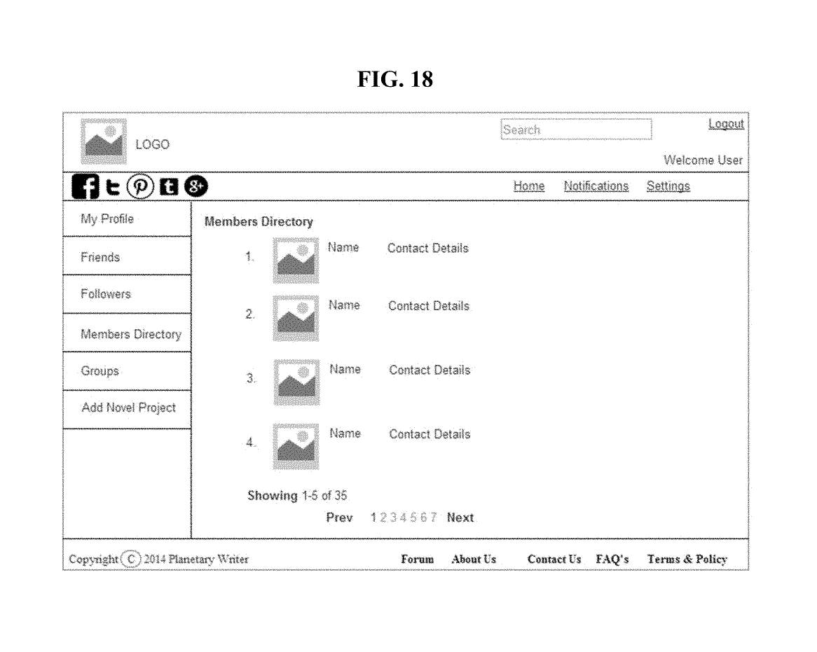

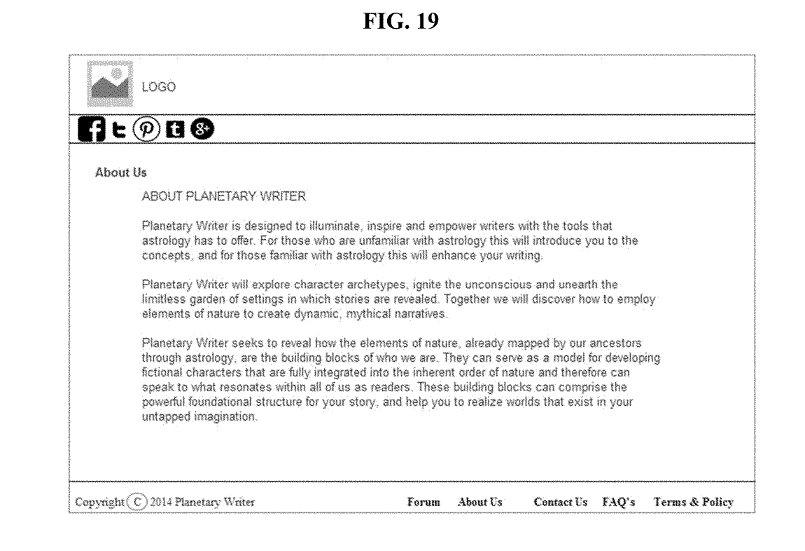

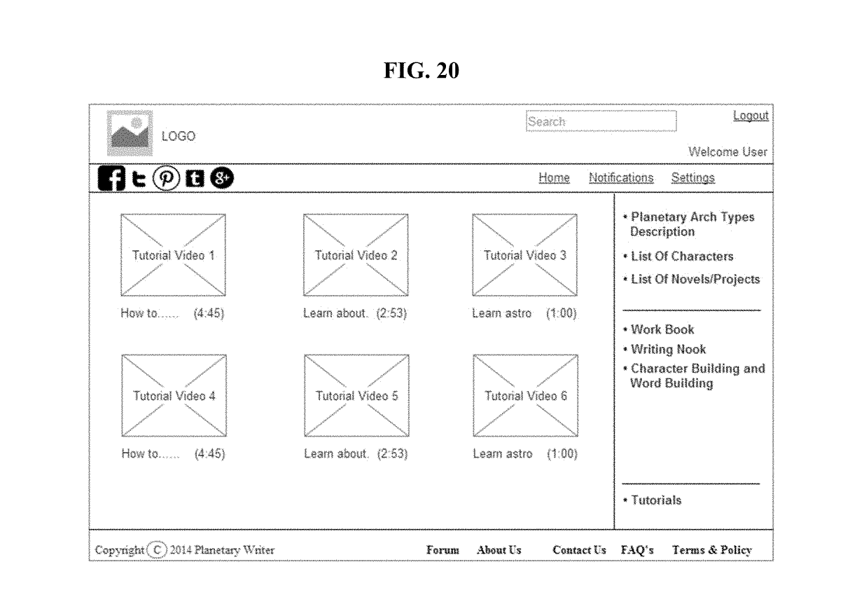

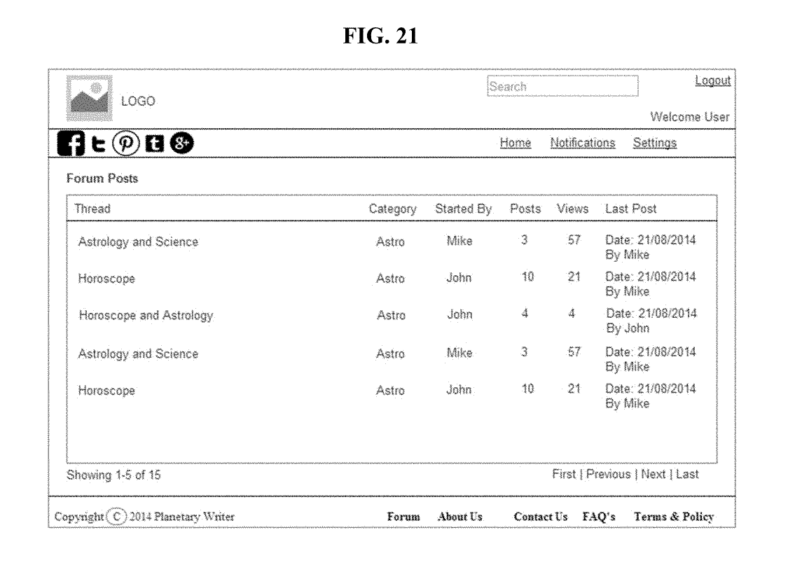

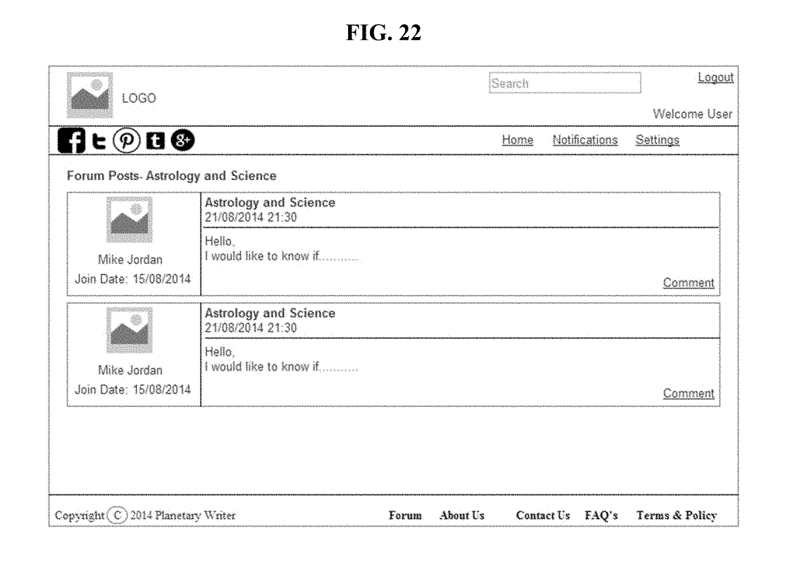

The 1^{st} house of the astrological chart. The 1^{st} house is naturally ruled by the planet Mars and its corresponding sign Aries. The character's past, future and current life indicated in FIG. 4 that correlates to Mars and Aries is the aspect of the character that controls the area of life of the 1^{st} house. Planets in degrees in signs that reside in the 1^{st} house indicate people, events and actions that provide further information for interpretation about the area of life for the character. If there is/are no planets in the 1^{st} house based on the chart used, then the sign/character that is on the cusps of the 1^{st} (100) house is in control of the area of life

The 2^{nd} house of the astrological chart. The 2^{nd} house is naturally ruled by the planet Venus and its corresponding sign Taurus. The character's past, future and current life indicated in FIG. 4 that correlates to Venus and Taurus is the aspect of the character that controls the area of life of the house. Planets in degrees in signs that reside in the 2^{nd} house indicate people, events and actions that provide further information for interpretation about the area of life for the character. If there is/are no planets in the 2^{nd} house based on the chart used, then the sign/character that is on the cusps of the 2^{nd} (101) house is in control of the area of life

The 3^{rd} house of the astrological chart. The 3^{rd} house is naturally ruled by the planet Mercury and its corresponding sign Gemini. The character's past, future and current life indicated in FIG. 4 that correlates to Mercury and Gemini is the aspect of the character that controls the area of life of the 3^{rd} house. Planets in degrees in signs that reside in the 3^{rd} house indicate people, events and actions that provide further information for interpretation about the area of life for the character. If there is/are no planets in the 3^{rd} house based on the chart used, then the sign/character that is on the cusps of the 3^{rd} (102) house is in control of the area of life

The 4^{th} house of the astrological chart. The 4^{th} house is naturally ruled by the planet Moon and its corresponding sign Cancer. The character's past, future and current life indicated in FIG. 4 that correlates to Moon and Cancer is the aspect of the character that controls the area of life of the 4^{th} house. Planets in degrees in signs that reside in the 4^{th} house indicate people, events and actions that provide further information for interpretation about the area of life for the character. If there is/are no planets in the 4^{th} house based on the chart used, then the sign/character that is on the cusps of the 4^{th} (200) house is in control of the area of life

The 5^{th} house of the astrological chart. The 5^{th} house is naturally ruled by the planet Sun and its corresponding sign Leo. The character's past, future and current life indicated in FIG. 4 that correlates to Sun and Leo is the aspect of the character that controls the area of life of the 5^{th} house. Planets in degrees in signs that reside in the 5^{th} house indicate people, events and actions that provide information about the area of life for the character. If there is/are no planets in the 5^{th} house based on the chart used, then the sign/character that is on the cusps of the 5^{th} (201) house is in control of the area of life

The 6^{th} house of the astrological chart. The 6^{th} house is naturally ruled by the planet Mercury and its corresponding sign Virgo. The character's past, future and current life indicated in FIG. 4 that correlates to Mercury and Virgo is the aspect of the character that controls the area of life of the 6^{th} house. Planets in degrees in signs that reside in the 6^{th} house indicate people, events and actions that provide information about the area of life for the character. If there is/are no planets in the 6^{th} house based on the chart used, then the sign/character that is on the cusps of the 6^{th} (202) house is in control of the area of life

The 7^{th} house of the astrological chart. The 7^{th} house is naturally ruled by the planet Venus and its corresponding sign Libra. The character's past, future and current life indicated in FIG. 4 that correlates to Venus and Libra is the aspect of the character that controls the area of life of the 7^{th} house. Planets in degrees in signs that reside in the 7^{th} house indicate people, events and actions that provide information about the area of life for the character. If there is/are no planets in the 7^{th} house based on the chart used, then the sign/character that is on the cusps of the 7^{th} (300) house is in control of the area of life

The 8^{th} house of the astrological chart. The 8^{th} house is naturally ruled by the planet Pluto/Mars and its corresponding sign Scorpio. The character's past, future and current life indicated in FIG. 4 that correlates to Pluto/Mars and Scorpio is the aspect of the character that controls the area of life of the 8^{th} house. Planets in degrees in signs that reside in the 8^{th} house indicate people, events and actions that provide information about the area of life for the character. If there is/are no planets in the 8^{th} house based on the chart used, then the sign/character that is on the cusps of the 8^{th} (301) house is in control of the area of life

The 9^{th} house of the astrological chart. The 9^{th} house is naturally ruled by the planet Jupiter and its corresponding sign Sagittarius. The character's past, future and current life indicated in FIG. 4 that correlates to Jupiter and Sagittarius is the aspect of the character indicated in FIG. 4 that controls the area of life of the 9^{th} house. Planets in degrees in signs that reside in the 9^{th} house indicate people, events and actions that provide information about the area of life for the character. If there is/are no planets in the 9^{th} house based on the chart used, then the sign/character that is on the cusps of the 9^{th} (302) house is in control of the area of life

The 10^{th} house of the astrological chart. The 10^{th} house is naturally ruled by the planet Saturn and its corresponding sign Capricorn. The character's past, future and current life indicated in FIG. 4 that correlates to Saturn and Capricorn is the aspect of the character that controls the area of life of the 10^{th} house. Planets in degrees in signs that reside in the 10th house indicate people, events and actions that provide information about the area of life for the character. If there is/are no planets in the 10^{th} house based on the chart used, then the sign/character that is on the cusps of the 10^{th} (400) house is in control of the area of life

The 11^{th} house of the astrological chart. The 11^{th} house is naturally ruled by the planet Uranus and its corresponding sign Aquarius. The character's past, future and current life indicated in FIG. 4 that correlates to Uranus and Aquarius is the aspect of the character that controls the area of life of the 11^{th} house. Planets in degrees in signs that reside in the 11th house indicate people, events and actions that provide information about the area of life for the character. If there is/are no planets in the 11^{th} house based on the chart used, then the sign/character that is on the cusps of the 11^{th} (401) house is in control of the area of life

The 12^{th} house of the astrological chart. The 12^{th} house is naturally ruled by the planet Neptune and its corresponding sign Pisces. The character's past, future and current life indicated in FIG. 4 that correlates to Neptune and Pisces is the aspect of the character that controls the area of life of the 12^{th} house. Planets in degrees in signs that reside in the 12th house indicate people, events and actions that provide information about the area of life for the character. If there is/are no planets in the 12^{th} house based on the chart used, then the sign/character that is on the cusps of the 12^{th} (402) house is in control of the area of life

In the astrological chart, it is the sign, degree and character that reside on the ascendant and marks the cusps of the first house. Indicates the beginning of the life or life span of the character or world on the W-storyboarding Map

The sign, degree and corresponding character that land on the cusp of the 12^{th} house is the major influence on the nature and the quality of action that is indicated by the 12^{th} house or the area of life for the character or world.

In the astrological chart of the novel, it is the cusps of the 11^{th} house. The sign, degree and corresponding character that land on the cusp of the 11^{th} house is the major influence on the nature and the quality of action that is indicated by the 11^{th} house or the area of life for the character or world.

It is when the character crosses the thresh hold and decides to take on the challenge of the plot. In the astrological chart, it is the sign, degree and character that reside on the Midheaven and marks the cusps of the fourth house. Indicates the goal and of the character or world and the area of life for the character or world.

In the astrological chart of the novel, it is the cusps of the 9^{th} house. The sign, degree and corresponding character that land on the cusp of the 9^{th} house is the major influence on the nature and the quality of action that is indicated by the 9^{th} house or the area of life for the character or world.

In the astrological chart of the novel, it is the cusps of the 8^{th} house. The sign, degree and corresponding character that land on the cusp of the 8^{th} house is the major influence on the nature and the quality of action that is indicated by the 8^{th} house or the area of life for the character or world.

Marks the turning point in the character life or world events. In the astrological chart, it is the sign, degree and character that reside on the descendant and marks the cusps of the 7th house.

In the astrological chart of the novel, it is the cusps of the 6^{th} house. The sign, degree and corresponding character that land on the cusp of the 6^{th} house is the major influence on the nature and the quality of action that is indicated by the 6^{th} house or the area of life for the character or world.

In the astrological chart of the novel, it is the cusps of the 5^{th} house. The sign, degree and corresponding character that land on the cusp of the 5^{th} house is the major influence on the nature and the quality of action that is indicated by the 5^{th} house or

the area of life for the character or world.

In the astrological chart, it is the sign, degree and character that reside on the Imum Coeli and marks the cusps of the 4^{th} house. Indicates the root and foundation of the character's life or world.

In the astrological chart of the novel, it is the cusps of the 3^{rd} house. The sign, degree and corresponding character that land on the cusp of the 3^{rd} house is the major influence on the nature and the quality of action that is indicated by the 3^{rd} house or the area of life for the character or world.

In the astrological chart of the novel, it is the cusps of the 2^{nd} house. The sign, degree and corresponding character that land on the cusp of the 2^{nd} house is the major influence on the nature and the quality of action that is indicated by the 2^{nd} house or the area of life for the character or world.

Aspects in astrology include the following politics of character and life interactions:
Conjunction
Trine
Sextile
Opposition
Square
Semi-sextile
Semi-square
Quintile
Quadrate
Sesquadrate

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, the subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone, or any other suitable portable or fixed electronic device.

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

Also, a computer may have one or more input and output devices. These devices can be used, among other things, to present a user interface (e.g., graphical user interface). To provide for interaction with a user, the subject matter described herein can be implemented on a computer having a display device (e.g., a CRT (cathode ray tube) monitor, LCD (liquid crystal display) monitor, or printer) for displaying information to the user and a keyboard and/or a pointing device (e.g., a mouse, touch pad, trackball, or touch screen), by which the user can provide input to the computer. As another example, a computer may receive input information through speech recognition or in other audible format. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), such as an enterprise network, an intelligent network (IN), or the Internet. Such networks may be based on any suitable technology and may operate according to any suitable protocol and may include wireless networks, wired networks, or fiber optic networks.

The processes and logic flows described in this specification, including the method steps of the subject matter described herein, can be performed by one or more programmable processors executing one or more computer programs to perform functions of the subject matter described herein by operating on input data and generating output. The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. The processes and logic flows can also be performed by, and apparatus of the subject matter described herein can be implemented as, special purpose logic circuitry, e.g., an FPGA (field programmable gate array) or an ASIC (application specific integrated circuit).

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

1. A method for facilitating a writing project using astrology, the writing project including at least one of a character, an object, a place, and an event, the method comprising:
determining a date, a time, and a place of birth for the at least one of the character, the object, the place, and the event;
acquiring an astrological chart based on the date, the time, and the place of birth for the at least one of the character, the object, the place, and the event, wherein the astrological chart comprises twelve houses disposed along a path of an ecliptic;
transposing the astrological chart on a storyboard to create an astrological story map by delineating, for each house, a cusp and any planets on the storyboard, beginning on an ascendant in direction east on the astrological chart, and moving along the path of the ecliptic, such that each house represents a section of the writing project;
replacing, for any planets on the astrological story map, each planet with at least one of a correlating character, a correlating object, a correlating place, and a correlating event, such that each of the at least one of the correlating character, the correlating object, the correlating place, and the correlating event interacts with the at least one of the character, the object, the place, and the event in one section of the writing project; and
providing the astrological story map to an author of the writing project.

2. The method of claim 1, wherein determining the date, the time, and the place of birth for the at least one of the character, the object, the place, and the event includes:
creating an archetypal question for the at least one of the character, the object, the place, and the event, the archetypal question being correlated to a type of answer the author needs; and
acquiring, via an graphical user interface, an answer to the archetypal question, the answer corresponding to at least one of an astrological planet, a node, and an asteroid.

3. The method of claim 2, wherein acquiring the astrological chart includes connecting the at least one of the character, the object, the place, and the event to a celestial location based at least in part on the answer to the archetypal question.

4. The method of claim 1, wherein creating the astrological story map includes generating a map structure including a first circle, a second circle, and an arrow, the arrow connecting the first circle and the second circle.

5. The method of claim 4, wherein the writing project is a story and at least one of the first circle and the second circle represents at least one of a turning point of a story and a beginning of an act of the story.

6. The method of claim 1, wherein the writing project includes at least one of a fiction story, a non-fiction story, an entertainment storyboard, a business plan, a research goal plan, and a goal plan.

7. A system for facilitating a writing project, the writing project concerning at least one of a character, an object, a place, and an event, the system comprising:
a communication interface;
a memory to store processor-executable instructions;
an input device;
an output device; and
a processor communicatively coupled to the communication device, the memory, the input device, and the output device, wherein upon execution of the processor-executable instructions, the processor:
receives from the input device a date, a time, and a place of birth for the at least one of the character, the object, the place, and the event;
acquires an astrological chart based on the date, the time, and the place of birth for the at least one of the character, the object, the place, and the event, wherein the astrological chart comprises twelve houses situated along a path of an ecliptic;
transposes the astrological chart on a storyboard to create an astrological story map by delineating, for each house, a cusp and any planets on the storyboard, beginning on an ascendant in direction east on the astrological chart, and moving along the path of the ecliptic, such that each house represents a section of the writing project;
replaces, for any planets on the astrological story map, each planet with at least one of a correlating character, a correlating object, a correlating place, and a correlating event, such that each of the at least one of the correlating character, the correlating object, the correlating place, and the correlating event interacts with the at least one of the character, the object, the place, and the event in one section of the writing project; and
at least one of provides the astrological story map to an author of the writing project, stores the astrological story map to the memory, and transmits the astrological story map using the communication interface.

8. The system of claim 7, wherein the processor is further configured to:
create an archetypal question for the at least one of the character, the object, the place, and the event, the archetypal question being correlated to a type of answer the author needs.

9. The system of claim 8, further comprising:
a graphical user interface communicatively coupled to the communication interface, the memory, the input device, the processor, and the output device, the graphical user interface to:
acquire an answer to the archetypal question, the answer corresponding to at least one of an astrological planet, a node, and an asteroid.

10. The system of claim of claim 9, wherein the processor is further configured to:
connect the at least one of the character, the object, the place, and the event to a celestial location based at least in part on the answer to the archetypal question.

11. The system of claim 7, wherein the processor is further configured to:
generate a map structure including a first circle, a second circle, and an arrow, the arrow connecting the first circle and the second circle.

12. The system of claim 11, wherein the writing project is a story and at least one of the first circle and the second circle represents at least one of a turning point of a story and a beginning of an act of the story.

13. The system of claim 7, wherein the writing project includes at least one of a fiction story, a non-fiction story, an entertainment storyboard a business plan, a research goal plan, and a goal plan.

14. A non-transitory computer readable storage medium encoded with processor-executable instruction that, when executed by a processor, perform a method for facilitating a writing project, the writing project concerning at least one of a character, an object, a place, and an event, the method comprising:
determining a date, a time, and a place of birth for the at least one of the character, the object, the place, and the event;
acquiring an astrological chart based on the date, the time, and the place of birth for the at least one of the character, the object, the place, and the event, wherein the astrological chart comprises twelve houses situated along a path of an ecliptic;
transposing the astrological chart on a storyboard to create an astrological story map by delineating, for each house, a cusp and any planets on the storyboard, beginning on an ascendant in direction east on the astrological chart, and moving along the path of the ecliptic, such that each house represents a section of the writing project;
replacing, for any planets on the astrological story map, each planet with at least one of a correlating character, a correlating object, a correlating place, and a correlating event, such that each of the at least one of the correlating character, the correlating object, the correlating place, and the correlating event interacts with the at least one of the character, the object, the place, and the event in one section of the writing project; and
providing the astrological story map to an author of the writing project.

15. The non-transitory computer readable storage medium of claim 14, wherein determining the date, the time, and the place of birth for the at least one of the character, the object, the place, and the event includes:
creating an archetypal question for the at least one of the character, the object, the place, and the event, the archetypal question being correlated to a type of answer the author needs; and
acquiring an answer to the archetypal question, the answer corresponding to at least one of an astrological planet, a node, and an asteroid.

16. The non-transitory computer readable storage medium of claim 15, wherein acquiring the astrological chart includes connecting the at least one of the character, the object, the place, and the event to a celestial location based at least in part on the answer to the archetypal question.

17. The non-transitory computer readable storage medium of claim 14, wherein creating the astrological story map includes generating a map structure including a first circle, a second circle, and an arrow, the arrow connecting the first circle and the second circle.

18. The non-transitory computer readable storage medium of claim 17, wherein the writing project is a story and at least one of the first circle and the second circle represents at least one of a turning point of a story and a beginning of an act of the story.

19. The non-transitory computer readable storage medium of claim 14, wherein the writing project includes at least one of a fiction story, a non-fiction story, an entertainment storyboard, a business plan, a research goal plan, and a goal plan.
